(19) United States
(12) Patent Application Publication
(10) Pub. No.: US 2026/0275582 A1
(43) Pub. Date: Sep. 17, 2026

(54) DOPE ADDITIVE AND FIBER

(71) Applicant: TORAY-OPELONTEX CO., LTD., Osaka (JP)

(72) Inventors: Toshihiro TANAKA, Osaka (JP); Kazuki NAESHIRO, Osaka (JP)

(21) Appl. No.: 19/168,925

(22) PCT Filed: Mar. 29, 2024
(86) PCT No.: PCT/IB2024/053113

§ 371 Date: Sep. 25, 2025

(30) Foreign Application Priority Data
Mar. 30, 2023 (JP) 2023-056752
Mar. 12, 2024 (JP) 2024-038265

(51) Int. Cl. D01F 6/70; C08J 3/09

(52) U.S. Cl. CPC D01F 6/70; C08J 3/096; C08J 2375/08; C08J 2375/12

(57) ABSTRACT

To provide an additive and the like. An additive is configured by a polyurethane (A) having a value of V2/V1 of 1 or more when: a viscosity of when dissolved in dimethylacetamide (DMAc) at 20% by mass at 40° C. is set to be V1; and a viscosity after 24 hours have additionally elapsed at 40° C. after dissolution is set to be V2.

### TECHNICAL FIELD

The present invention relates to a dope additive, a dope, fibers (polyurethane fibers and the like), and the like.

### BACKGROUND ART

Solution formation is often used in molding (forming) of polyurethane. Examples include solution spinning and solution cast films (patent literature 1 and the like).

### PRIOR ART LITERATURE

### Patent Literature

[Patent Document 1] WO 2015/056763

### SUMMARY OF INVENTION

### Problem to be Solved by Invention

An object of the present invention is to provide a novel additive (dope additive), dope, polyurethane fiber (polyurethane elastic fiber), and the like.

### Means for Solving Problem

As described above, solution formation is often used for molding (forming) of polyurethane.

In such circumstances, as a result of extensive studies, the present inventors have discovered that by selecting specific components as components (additives) to be compounded in a solution (dope), it is possible to realize, inter alia, efficient molding of polyurethane [for example, polyurethane fibers (elastic fibers)] and the production of polyurethane [for example, polyurethane fibers (elastic fibers)] having favorable physical properties, thereby completing the present invention.

That is, the present invention relates to inventions such as the following.

[1]

A dope additive, wherein the additive is comprised of a polyurethane (A) having a value of V2/V1 of 1 or more when, at 40° C., V1 is a viscosity when dissolved (or dispersed) in dimethylacetamide (DMAc) at 20% by mass (at a concentration of 20% by mass), and V2 is a viscosity after a further 24 hours have passed after being dissolved (or dispersed) [at 40° C., V1 is a viscosity when dissolved (or dispersed) in dimethylacetamide (DMAc) at 20% by mass (at a concentration of 20% by mass), and V2 is a viscosity after a further 24 hours have passed at 40° C., after being dissolved (or dispersed) (viscosity after 24 hours have passed as is at 40° C. after being dissolved at 40° C.)].

[2]

The additive according to [1], wherein the value of V2/V1 of the polyurethane (A) is 1.01 or more.

[3]

The additive according to [1] or [2], wherein the value of V2/V1 of the polyurethane (A) is 5 or less (for example, 4.3 or less or 4.1 or less).

[4]

The additive according to any of [1] to [3], wherein the value of V2/V1 of the polyurethane (A) is 1.02 to 3.5.

[5]

The additive according to any of [1] to [4], wherein V2 of the polyurethane (A) is 1,000 poise or more.

[6]

The additive according to any of [1] to [5], wherein the polyurethane (A) satisfies the following (i) or (ii):
(i) V2 is 1,000 to 5,000 poise, and the value of V2/V1 is 1.05 or more
(ii) V2 is over 5,000 poise and the value of V2/V1 is 3.5 or less
   [7]

The additive according to any of [1] to [6], wherein a number average molecular weight of the polyurethane (A) is 10,000 or more.

[8]

The additive according to any of [1] to [7], wherein the polyurethane (A) has a peak in a region of a molecular weight (number average molecular weight) of one million or more in GPC.

[9]

The additive according to any of [1] to [8], wherein the polyurethane (A) has an amino group.

[10]

The additive according to any of [1] to [9], wherein the polyurethane (A) has the amino group at a proportion of 0.1 meq/kg or more.

[11]

The additive according to any of [1] to [10], wherein the polyurethane (A) has the amino group at a proportion of 50 meq/kg or less.

[12]

The additive according to any of [1] to [11], wherein the polyurethane (A) has the amino group at a proportion of 0.1 to 50 meq/kg.

[13]

The additive according to any of [1] to [12], wherein the polyurethane (A) has the amino group at a proportion of 1 to 30 meq/kg (for example, 2 to 25 meq/kg).

[14]

The additive according to any of [1] to [13], wherein the polyurethane (A) contains a metal soap (for example, contains a metal soap at a proportion of 0.003 to 3% by mass).

[15]

The additive according to any of [1] to [14], wherein the polyurethane (A) contains at least one selected from a surfactant, an antioxidant, a tertiary amine compound, and a crosslinked structure regulator (for example, contains a surfactant at a proportion of 0.003 to 3% by mass and/or contains an antioxidant at a proportion of 0.002 to 5% by mass).

[16]

The additive according to any of [1] to [15], wherein the polyurethane (A) is fibrous.

[17]

The additive according to any of [1] to [16], wherein the polyurethane (A) is (or is derived from) at least one selected from molded products [(for example, a fiber (thread)], molding scraps, and post-consumer products [for example, a fiber (thread)] that has been stored for one month or more after manufacturing.

[18]

The additive according to any of [1] to [17], being a viscosity modifier (viscosity control agent, viscosity increasing agent, thickener).

[19]

The additive according to any of [1] to [18], wherein the dope is a polyurethane dope.

[20]

A dope additive, wherein the additive is comprised of the polyurethane (A) having an amino group (for example, having an amino group at a proportion of 0.1 to 50 meq/kg).

[21]

A dope additive, wherein the additive is comprised of the polyurethane (A) having an amino group at a proportion of 1 to 30 meq/kg (for example, 2 to 25 meq/kg).

[22]

A dope containing the polyurethane (A) according to any of [1] to [21].

[23]

The dope according to [22], wherein a proportion of the polyurethane (A) is 1% by mass or more.

[24]

The dope according to [22] or [23], further containing a resin (B).

[25]

The dope according to any of [22] to [24], further containing the resin (B), wherein the resin (B) contains a polyurethane (B).

[26]

The dope according to any of [22] to [26], further containing the resin (B), wherein a proportion of the polyurethane (A) to a total amount of the polyurethane (A) and the resin (B) is 3% by mass or more.

[27]

The dope according to any of [22] to [26], further containing the resin (B), wherein: the resin (B) contains the polyurethane (B) and the proportion of the polyurethane (A) to a total amount of the polyurethane (A) and the polyurethane (B) is 5% by mass or more (for example, 10 to 90% by mass).

[28]

The dope according to any of [22] to [27], wherein a number average molecular weight of the resin constituting the dope is 10,000 or more.

[29]

The dope according to any of [22] to [28], wherein the resin constituting the dope has a peak in a region of a molecular weight (number average molecular weight) of one million or more in GPC.

[30]

The dope according to any of [22] to [29], containing a solvent (for example, a solvent containing at least one selected from amide solvents and sulfur solvents).

[31]

The dope according to any of [22] to [30], containing a solvent and having a solid content concentration of 5 to 80% by mass.

[32]

The dope according to any of [22] to [31], wherein the value of V2/V1 is 0.8 or more when, at 40° C., V1 is a viscosity during preparation, and V2 is a viscosity after a further 24 hours have passed after preparation [when V2 is a viscosity at 40° C. after 24 hours have passed (viscosity after 24 hours have passed as is at 40° C. after being dissolved at 40° C.)].

[33]

The dope according to any of [22] to [32], wherein the value of V2/V1 is 1 or more (for example, 1 to 5) when, at 40° C., V1 is a viscosity during preparation, and V2 is a viscosity after a further 24 hours have passed after preparation [when V2 is a viscosity at 40° C. after 24 hours have passed (viscosity after 24 hours have passed as is at 40° C. after being dissolved at 40° C.)].

[34]

The dope according to any of [22] to [33], wherein the value of V2/V1 is 1.01 to 3.5 when, at 40° C., V1 is a viscosity during preparation, and V2 is a viscosity after a further 24 hours have passed after preparation [when V2 is a viscosity at 40° C. after 24 hours have passed (viscosity after 24 hours have passed as is at 40° C. after being dissolved at 40° C.)], and a viscosity is 1,000 to 10,000 poise.

[35]

A method for producing a molded product using the dope according to any of [22] to [34] {for example, a method for producing a fiber [a thread, for example, a polyurethane fiber (thread)] by spinning the dope according to any of [22] to [34]}.

[36]

A molded product obtained using the dope according to any of [22] to [34].

[37]

A molded product containing the polyurethane (A) according to any of [1] to [21].

[38]

The molded product according to [36] or [37], being a fiber [a thread, for example, a polyurethane fiber (thread)].

[39]

The molded product according to any of [36] to [38], wherein the constituent resin (resin constituting the molded product) has a peak in a region of a molecular weight (number average molecular weight) of one million or more in GPC.

[40]

The molded product according to any of [36] to [39], containing at least one selected from metal soaps, surfactants, antioxidants, tertiary amine compounds, and crosslinked structure regulators.

[41]

The molded product according to any of [36] to [40], being a fiber [thread, for example, polyurethane fiber (thread)], wherein the constituent resin has a peak in a region of a molecular weight (number average molecular weight) of one million or more in GPC, and contains a metal soap at a proportion of 0.003 to 3% by mass.

### Effect of Invention

According to the present invention, it is possible to provide a novel additive.

Such an additive is comprised of a specific polyurethane and can improve molding or physical properties (particularly, both molding and physical properties) of the polyurethane.

For example, in one aspect of the additive of the present invention, thread breakage during spinning can be suppressed or prevented, and polyurethane fibers can be efficiently produced. Although such efficient molding is a use aspect for an additive, it is possible to produce an equivalent or even more excellent product compared to, for example, simply producing a dope (polymerization) and spinning.

In addition, in another aspect of the additive of the present invention, favorable or improved physical properties {for example, at least one selected from strength (rupture strength and the like), elongation (rupture elongation and the like), heat resistance, durability [for example, maintenance of strength and the like (for example, maintenance when exposed to environments such as ultraviolet rays, NOx, chlorine and the like (particularly in a compound environment combining these))], and yellowing resistance (for example, at least one selected from strength, elongation, heat resistance, and durability)} can be realized.

### EMBODIMENTS OF THE INVENTION

### <Additive>

The additive of the present invention is comprised of a specific polyurethane (may be referred to as polyurethane (A) and the like). Such an additive may be, for example, a dope additive.

### [Polyurethane (A)]

The polyurethane (A) may exhibit a specific viscosity behavior in a solvent (polar solvent).

Specifically, the polyurethane (A), at 40° C., has a proportion (ratio, rate, viscosity ratio, viscosity after 24 hours/initial viscosity, V2/V1) between a viscosity (initial viscosity, V1) when dissolved (dispersed) (mixed) in dimethylacetamide (N,N-dimethylacetamide, DMAc) at a concentration of 20% by mass, and a viscosity (viscosity after 24 hours, V2) after a further 24 hours (left to stand) after being dissolved (mixed) [viscosity after 24 hours have further passed (left to stand) at 40° C. (after 24 hours have passed as is at 40° C. after being dissolved at 40° C.)] that may be selected from a range of 1 or more (for example, more than 1, 1.001 or more, or 1.005 or more), and may satisfy, for example, 1.01 or more (for example, 1.02 or more), preferably 1.03 or more (for example, 1.04 or more), more preferably 1.05 or more (for example, 1.06 or more), or may satisfy 1.08 or more (for example, 1.1 or more, 1.15 or more, 1.2 or more, 1.25 or more, 1.3 or more, 1.35 or more, 1.4 or more, 1.45 or more, 1.5 or more, 1.55 or more, 1.6 or more, 1.7 or more, 1.8 or more, 1.9 or more, 2 or more, 2.1 or more, 2.2 or more, 2.3 or more, 2.4 or more, 2.5 or more, 2.6 or more, 2.7 or more, 2.8 or more, 2.9 or more, 3 or more, 3.1 or more, or 3.2 or more and the like).

The (upper limit value of the) foregoing viscosity after 24 hours/initial viscosity (V2/V1) is not particularly limited, and may be selected from a range of about, for example, 20 or less (for example, 15 or less), and may be for example, 10 or less (for example, 8 or less), preferably 7 or less (for example, 6 or less), more preferably 5 or less (for example, 4.5 or less, 4.4 or less, 4.3 or less, 4.2 or less, or 4.1 or less), or particularly 4 or less (for example, 3.8 or less, 3.7 or less, 3.6 or less, 3.5 or less, or 3.4 or less), and this may also be set to about 3.3 or less (for example, 3.2 or less, 3.1 or less, 3 or less, 2.9 or less, 2.8 or less, 2.7 or less, 2.6 or less, 2.5 or less, 2.4 or less, 2.3 or less, 2.2 or less, 2.1 or less, 2 or less, 1.9 or less, 1.8 or less, 1.7 or less, 1.6 or less, 1.5 or less, 1.4 or less, or 1.3 or less).

Note that a range may be selected by appropriately combining these ranges (upper limit value and lower limit value) (for example, 1 to 10, 1.01 to 5, and the like; the same applies to descriptions of ranges hereinafter).

Specific examples of the viscosity after 24 hours/initial viscosity (V2/V1) include 1 to 10, 1.01 to 5, 1.05 to 4, 1.03 to 3.5, 1.1 to 3.3, 1.2 to 3.5, 1.05 to 3, 1.05 to 1.2, and the like.

When the viscosity after 24 hours/initial viscosity (V2/V1) is as such, it is easy to realize efficient molding of polyurethane (for example, favorable spinnability) and to obtain polyurethane having favorable physical properties. For example, reasons such as the following are conceivable as such reasons.

Firstly, as described above, polyurethane is molded in a molten state (particularly by solution molding), and studies by the present inventors found that viscidity (viscosity) is important in such molding.

Specifically, when the viscidity is not sufficient or appropriate (or when such viscidity cannot be maintained or preserved over time), moldability (spinnability and the like) may be impaired, such as thread breakage occurring more readily, and physical properties (for example, strength, elongation, heat resistance, and durability) of the obtained molded product may be impaired.

Note that although the reason is not clear, it is thought that the viscidity of polyurethane is largely due to association owing to strong hydrogen bonding of polyurethane, and thus when such association is not sufficient, it may be difficult to obtain sufficient viscidity as well.

Also, when such association (viscidity) is not sufficient, it is expected that sufficient strength will not be obtained during molding, molding defects such as thread breakage will be more likely to occur, and additionally, having insufficient association that is thought to affect the expression of physical properties affects (is reflected in) the obtained molded product as well [for example, association in the molded product is low or easily becomes nonuniform], impairing physical properties.

Conversely, a V2/V1 (change in viscosity over time) as described above is considered to be related to ease of thickening (and ease of maintaining or continuing a thickened state), and in turn, ease of association. In other words, polyurethane having a V2/V1 as described above maintains or increases (maintains or increases, over time) in viscidity (association) and even when compounded with a resin or a polymer system thereof (for example, polyurethane or the polymer system thereof), not to mention when used alone, sufficient viscidity or association is manifested or induced, viscidity decrease over time is kept to a minimum, and in particular, depending on the combined target and compounding proportion thereof, it is conceivable that viscidity will be increased more, accompanying which, it is conceivable that this could lead to favorable moldability and physical properties of the molded product.

Note that when the viscidity becomes too large, it may conversely impair spinnability and physical properties, and thus the value of V2/V1 and usage proportion (compounding proportion) of the polyurethane (A) may be selected according to the viscidity of the (combined) compounded target (for example, polyurethane) or the like.

For example, when the viscidity of the target to be compounded is relatively high, a polyurethane (A) with a value of V2/V1 that is not too large may be selected, or the compounding proportion may be reduced.

The initial viscosity (V1) of the polyurethane (A) is not limited, but it may be selected from a range of about 10 poise (=1 Pa·s=1,000 mPa·s) or more, may be about 100 poise or more (for example, 200 poise or more, 300 poise or more, or 400 poise or more), preferably 500 poise or more (for example, 600 poise or more, 700 poise or more, or 800 poise or more), or more preferably 1,000 poise or more (for example, 1,100 poise or more or 1,200 poise or more), and may also be set to 1,300 poise or more (for example, 1,400 poise or more, 1,500 poise or more, 1,600 poise or more, 1,700 poise or more, 1,750 poise or more, 1,800 poise or more, 1,900 poise or more, 2,000 poise or more, 2,100 poise or more, 2,200 poise or more, 2,300 poise or more 2,400 poise or more, 2,500 poise or more, 2,600 poise or more, 2,700 poise or more, 2,800 poise or more, 2,900 poise or more, 3,000 poise or more, 3,100 poise or more, 3,200 poise or more, 3,300 poise or more, 3,400 poise or more, 3,500 poise or more, 3,600 poise or more, 3,700 poise or more, 3,800 poise or more, 3,900 poise or more, or 4,000 poise or more) or the like.

Sufficient viscidity and the like can be achieved by satisfying a V2/V1 as described above, but when the initial viscosity is too low, it may be difficult to efficiently realize sufficient viscidity and the like (for example, taking an excessive amount of time to reach sufficient viscidity, or the like), though this depends on the compounding target, compounding proportion, and V2 value as well, so the initial viscosity such as described above may be set so as to not be too low.

The (upper limit value of the) initial viscosity (V1) of the polyurethane (A) is not limited, but may be selected from a range of about 100,000 poise or less, may be about 80,000 poise or less (for example, 60,000 poise or less, 50,000 poise or less, or 40,000 poise or less), preferably 30,000 poise or less (for example, 20,000 poise or less, 15,000 poise or less, or 12,000 poise or less), and more preferably 10,000 poise or less (for example, 9,000 poise or less, or 8,000 poise or less), or may be set to 7,000 poise or less (for example, 6,500 poise or less, 6,000 poise or less, 5,500 poise or less, 5,000 poise or less, 4,500 poise or less, 4,400 poise or less, 4,300 poise or less, 4,200 poise or less, 4,100 poise or less, 4,000 poise or less, 3,900 poise or less, 3,800 poise or less, 3,700 poise or less, 3,600 poise or less, 3,500 poise or less, 3,400 poise or less, 3,300 poise or less, 3,200 poise or less, 3,100 poise or less, 3,000 poise or less, 2,900 poise or less, 2,800 poise or less, 2,700 poise or less, 2,600 poise or less, 2,500 poise or less, 2,400 poise or less, 2,300 poise or less, 2,200 poise or less, 2,100 poise or less, 2,000 poise or less, 1,900 poise or less, 1,850 poise or less, or 1,800 poise or less) or the like.

Sufficient viscidity and the like can be achieved by satisfying a V2/V1 as described above, but when the initial viscosity is too high, excessive viscidity may develop, though this depends on the compounding target, compounding proportion, and V2 value as well, so the initial viscosity such as described above may be set so as to not be too high.

The viscosity after 24 hours have passed (V2) of the polyurethane (A) may, for example, be selected from a range of about 50 poise (=5 Pa·s=5,000 mPa·s) or more, may be about 300 poise or more (for example, 400 poise or more, 500 poise or more, or 600 poise or more), preferably 700 poise or more (for example, 800 poise or more, 900 poise or more, or 1,000 poise or more), and more preferably 1,100 poise or more (for example, 1,200 poise or more or 1,300 poise or more), and may be set to 1,400 poise or more (for example, 1,500 poise or more, 1,600 poise or more, 1,700 poise or more, 1,800 poise or more, 1,900 poise or more, 1,950 poise or more, 2,000 poise or more, 2,100 poise or more, 2,200 poise or more, 2,300 poise or more, 2,400 poise or more, 2,500 poise or more, 2,600 poise or more, 2,700 poise or more, 2,800 poise or more, 2,900 poise or more, 3,000 poise or more, 3,100 poise or more, 3,200 poise or more, 3,300 poise or more, 3,400 poise or more, 3,500 poise or more, 3,600 poise or more, 3,700 poise or more, 3,800 poise or more, 3,900 poise or more, 4,000 poise or more, 4,200 poise or more, 4,500 poise or more, 5,000 poise or more, 5,500 poise or more, 6,000 poise or more, 6,500 poise or more, 7,000 poise or more, 7,500 poise or more, 8,000 poise or more, or 8,500 poise or more) or the like.

Sufficient viscidity and the like can be achieved by satisfying a V2/V1 as described above, but when the V2 is too low, it may be difficult to efficiently realize sufficient viscidity and the like (for example, taking an excessive amount of time to reach sufficient viscidity, or the like), though this depends on the compounding target and compounding proportion as well, so the V2 such as described above may be set so as to not be too low.

The (upper limit value of the) viscosity after 24 hours have passed (V2) of the polyurethane (A) may be selected from a range of about 1,000,000 poise or less, may be 500,000 poise or less (for example, 400,000 poise or less, 300,000 poise or less, or 200,000 poise or less), preferably 100,000 poise or less (for example, 80,000 poise or less, 70,000 poise or less, or 60,000 poise or less), more preferably 50,000 poise or less (for example, 40,000 poise or less or 30,000 poise or less), and may be set to 25,000 poise or less (for example, 22,000 poise or less, 20,000 poise or less, 18,000 poise or less, 15,000 poise or less, 14,000 poise or less, 13,000 poise or less, 12,000 poise or less, 11,500 poise or less, 11,000 poise or less, 10,500 poise or less, 10,000 poise or less, 9,500 poise or less, 9,000 poise or less, 8,800 poise or less, 8,500 poise or less, 8,000 poise or less, 7,500 poise or less, 7,000 poise or less, 6,800 poise or less, 6,500 poise or less, 5,000 poise or less, 4,500 poise or less, 4,000 poise or less, 3,500 poise or less, 3,200 poise or less, 3,000 poise or less, 2,900 poise or less, 2,800 poise or less, 2,700 poise or less, 2,600 poise or less, 2,500 poise or less, 2,400 poise or less, 2,300 poise or less, 2,200 poise or less, 2,100 poise or less, or 2,000 poise or less) or the like.

Sufficient viscidity and the like can be achieved by satisfying a V2/V1 as described above, but when the V2 is too high, excessive viscidity may develop, though this depends on the compounding target and value of the compounding proportion as well, so the V2 such as described above may be set so as to not be too high.

Note that the viscosities described above (V1 and V2) may be measured by: setting a state sufficiently dissolved (dispersed) at 40° C. in DMAc at a concentration (proportion) of 20% by mass to be a starting point (initial viscosity (V1)); setting the point in time when 24 hours has elapsed after this starting point (viscosity after 24 hours (V2)) to be the end point; and using a viscometer (for example, a falling-ball viscometer) (for example, according to the method of ASTM D1343-69) and, for example, may be measured according to a method described later.

The number average molecular weight of the polyurethane (A) may be selected from a range of about 2,000 or more (for example, 3,000 or more or 4,000 or more), may be, for example, 5,000 or more (for example, 6,000 or more or 7,000 or more), preferably 8,000 or more (for example, 9,000 or more), and more preferably about 10,000 or more (for example, 11,000 or more, 12,000 or more, 13,000 or more, or 14,000 or more), or may be about 15,000 or more (for example, 16,000 or more, 17,000 or more, 18,000 or more, 19,000 or more, 20,000 or more, 21,000 or more, 22,000 or more, 23,000 or more, 24,000 or more, 25,000 or more, 26,000 or more, 27,000 or more, or 28,000 or more).

Sufficient viscidity and the like can be achieved by satisfying a V2/V1 as described above, but when the number average molecular weight is too low, it may be difficult to efficiently realize sufficient viscidity and the like (for example, taking an excessive amount of time to reach sufficient viscidity, or the like), though this depends on the compounding target, compounding proportion, and value of V2/V1 as well, so the number average molecular weight such as described above may be set so as to not be too low. Furthermore, from the perspective of physical properties such as strength and durability, it is preferable that the number average molecular weight not be too small.

Note that the (upper limit value of the) number average molecular weight of the polyurethane (A) is not limited, but may be selected from a range of about 2,000,000 or less (for example, 1,500,000 or less or 1,200,000 or less), may be, for example, about 1,000,000 or less (for example, 800,000 or less or 700,000 or less), preferably 500,000 or less (for example, 300,000 or less), and more preferably 200,000 or less (for example, 180,000 or less, 150,000 or less, or 120,000 or less), or may be about 100,000 or less (for example, 90,000 or less, 80,000 or less, 70,000 or less, 60,000 or less, 55,000 or less, 50,000 or less, 45,000 or less, 40,000 or less, or 35,000 or less).

Specific examples of the number average molecular weight of polyurethane include 10,000 to 300,000, 20,000 to 200,000, and 30,000 to 150,000, or the like.

In particular, the polyurethane (A) may have a peak owing to a high molecular weight component in GPC (GPC chart) [for example, generally, a peak in a molecular weight (number average molecular weight) region of about 1 million or more (for example, 1 million to 50 million, 1 million to 30 million, 2 million to 15 million, or 3 million to 10 million)].

According to the present inventors' studies, such a high molecular weight component may contribute to an increase in viscidity (increase over time), perhaps because it functions as a component that induces or promotes association (for example, functioning as a drug expander), and when coupled with satisfaction (in addition to satisfaction) of the value of V2/V1 described above, the polyurethane (A) containing the high molecular weight component may be suitably used, though this depends on the compounding target, compounding proportion, value of V2/V1, desired viscidity (degree of viscidity), and the like.

On the other hand, even with a polyurethane (A) that does not contain a high molecular weight component, when, for example, using in applications not containing a high molecular weight component where it is possible to achieve desired functions and physical properties, polyurethane (A) that does not contain a high molecular weight component may be obtained from polyurethane (A) containing a high molecular weight component through a process that allows the high molecular weight component to be separated (for example, by dissolving or dispersing in an appropriate solvent and then filtering).

Note that the polyurethane (A) having such a high molecular weight component is not particularly limited and may be obtained by separately compounding a high molecular weight component together with polyurethane or the like, but there are also cases where polyurethane molded by various molding methods (for example, solution molding) and the like contains a high molecular weight component, and polyurethane originally containing such a high molecular weight component may be used as is.

Note that the molecular weight (number average molecular weight) and the presence or absence of a high molecular weight component may be confirmed (measured) by, for example, GPC (polystyrene conversion and the like), and specifically, may be confirmed (measured) by a method described later (the same, hereinafter).

The polyurethane (A) may have an amino group (terminal amino group).

In such polyurethane (A) (polyurethane (A) having an amino group), a proportion of the amino group (lower limit value of proportion and concentration) may be selected from a range of about, for example, 0.01 meq/kg [mmol equivalent/kg, mmol/kg, mmol (mmol equivalent)/kg as amino group] or more (for example, 0.03 meq/kg or more, or 0.05 meq/kg or more), may be about 0.1 meq/kg or more (for example, 0.2 meq/kg or more, 0.3 meq/kg or more, 0.4 meq/kg or more, 0.5 meq/kg or more, 0.6 meq/kg or more, 0.7 meq/kg or more, 0.8 meq/kg or more, or 0.9 meq/kg or more), preferably 1 meq/kg or more (for example, 1.1 meq/kg or more, 1.2 meq/kg or more, 1.3 meq/kg or more, or 1.4 meq/kg or more), more preferably 1.5 meq/kg or more (for example, 1.6 meq/kg or more, 1.7 meq/kg or more, 1.8 meq/kg or more, or 1.9 meq/kg or more), and may be 2 meq/kg or more (for example, 2.2 meq/kg or more, 2.5 meq/kg or more, 3 meq/kg or more, 3.5 meq/kg or more, 4 meq/kg or more, 4.5 meq/kg or more, 5 meq/kg or more, 5.5 meq/kg or more, 6 meq/kg or more, 6.5 meq/kg or more, 7 meq/kg or more, 7.5 meq/kg or more, 8 meq/kg or more, 8.5 meq/kg or more, 9 meq/kg or more, 9.5 meq/kg or more, 10 meq/kg or more, 10.5 meq/kg or more, 11 meq/kg or more, 11.5 meq/kg or more, 12 meq/kg or more, 12.5 meq/kg or more, 13 meq/kg or more, 13.5 meq/kg or more, 14 meq/kg or more, 14.5 meq/kg or more, 15 meq/kg or more, 15.5 meq/kg or more, 16 meq/kg or more, 16.5 meq/kg or more, 17 meq/kg or more, 17.5 meq/kg or more, 18 meq/kg or more, 18.5 meq/kg or more, 19 meq/kg or more, 19.5 meq/kg or more, or 20 meq/kg or more).

In the polyurethane (A) (polyurethane (A) having an amino group), the proportion of the amino group (upper limit value of concentration and proportion) may be selected from a range of about, for example, 100 meq/kg or less (for example, 80 meq/kg or less, 70 meq/kg or less, or 60 meq/kg or less), may be 50 meq/kg or less (for example, 45 meq/kg or less), preferably 40 meq/kg or less (for example, 35 meq/kg or less), more preferably 30 meq/kg or less (for example, 29 meq/kg or less, 28 meq/kg or less, 27 meq/kg or less, 26 meq/kg or less, 25 meq/kg or less, 24 meq/kg or less, 23 meq/kg or less, 22 meq/kg or less, 21 meq/kg or less), and may particularly be 20 meq/kg or less (for example, less than 20 meq/kg, 19 meq/kg or less, 18.5 meq/kg or less, 18 meq/kg or less, 17.5 meq/kg or less, 17 meq/kg or less, 16.5 meq/kg or less, 16 meq/kg or less, 15.5 meq/kg or less, 15 meq/kg or less, 14.5 meq/kg or less, 14 meq/kg or less, 13.5 meq/kg or less, 13 meq/kg or less, 12.5 meq/kg or less, 12 meq/kg or less, 11.5 meq/kg or less, 11 meq/kg or less, 10.5 meq/kg or less, 10 meq/kg or less, 9.5 meq/kg or less, 9 meq/kg or less, 8.5 meq/kg or less, 8 meq/kg or less, 7.5 meq/kg or less, or 7 meq/kg or less), or the like.

In particular, it is preferable that the amino group concentration of the polyurethane (A) is neither too small nor too large (furthermore, neither too small nor too large).

From this perspective, the amino group concentration of the polyurethane (A) may be, for example, 0.1 meq/kg or more (for example, 0.3 meq/kg or more, 0.5 meq/kg or more, 1 meq/kg or more, 1.5 meq/kg, or 2 meq/kg or more) or the like, and may be 50 meq/kg or less (for example, 45 meq/kg or less, 40 meq/kg or less, 35 meq/kg or less, 30 meq/kg or less, 25 meq/kg or less, 20 meq/kg or less, 18 meq/kg or less, 15 meq/kg or less, 12 meq/kg or less, or 10 meq/kg or less) or the like, preferably 0.1 to 50 meq/kg (for example, 0.3 to 40 meq/kg, 0.3 to 35 meq/kg, 0.3 to 30 meq/kg, 0.5 to 28 meq/kg), more preferably 1 to 30 meq/kg (for example, 1 to 28 meq/kg, 1.2 to 25 meq/kg, 1.2 to 22 meq/kg, 1.5 to 26 meq/kg, 1.5 to 25 meq/kg, 1.5 to 20 meq/kg, 1.8 to 10 meq/kg, 2 to 8 meq/kg, 3 to 22 meq/kg, 4 to 20 meq/kg, 5 to 20 meq/kg, 2 to 26 meq/kg, 2 to 22 meq/kg), or the like.

According to the present inventors' studies, it appears that such an amino group may contribute to induction or promotion of association and to an increase in viscidity (increase over time), and by selecting the amino group concentration, [particularly, in combination with satisfaction (in addition to satisfaction) of the above-mentioned value of V2/V1], it seems that it is easy to efficiently impart sufficient viscidity and control the increase in viscosity. Therefore, in terms of efficient molding of polyurethane and production of polyurethane having favorable physical properties, a polyurethane (A) [particularly, as mentioned above, of an amino group at a proportion that is not too small and/or not too large (particularly not too small or too large)] having an amino group may be suitably used.

Not that the polyurethane (A) having such an amino group may or may not contain the above-mentioned high molecular weight component. In particular, when the polyurethane (A) has the amino group at the above ratio, efficient molding of polyurethane and production of polyurethane having favorable physical properties can be easily realized even when a high molecular weight component is contained.

The presence or absence of the amino group and the ratio thereof may be confirmed (measured) by a conventional method (for example, potentiometric titration), and specifically, may be confirmed (measured) by a method described later.

Note that, when the polyurethane used as a raw material does not have the desired ratio of the amino group as mentioned above, it may also be adjusted so as to have the desired ratio of the amino group. For example, by bringing the polyurethane as a raw material and a secondary amine (such as diethylamine) into contact (reacting), the proportion of the amino group may be made smaller, and by bringing the polyurethane as a raw material and a primary amine (such as ethylenediamine) into contact (reacting), the proportion of the amino group may be made larger.

In addition, the ratio of the amino group in the polyurethane may be adjusted (for example, made larger) by treatments that may cause partial cleavage or recombination of polyurethane chains (for example, heat treatment, stirring treatment using stirring means, or the like) or the like.

A shape (aspect) of the polyurethane (A) is not particularly limited and may be fibrous, non-fibrous [granular, powder, coarsely ground molded product (non-fibrous lump), and the like], or the like.

A fiber diameter (average fiber diameter) of the fibrous polyurethane (A) is not particularly limited but may be, for example, about 1 to 10,000 μm, preferably 10 to 5,000 μm, and more preferably 20 to 2,000 μm.

A size (size, length in fibers) of the polyurethane (A) is not particularly limited, but in view of handleability, compounding, usage aspect, and the like, the average diameter (maximum diameter) may be a relatively small size, such as 10 mm or less [for example, 5 mm or less (for example, 3 mm or less), preferably 1 mm or less, and more preferably 0.5 mm or less].

Note that the polyurethane (A) of such a size may be obtained by, for example, a general-purpose pulverization process, though this depends on the aspect of the polyurethane used as a raw material.

Note that the fiber diameter and size may be measured using, for example, a scanning electron microscope (SEM).

Specifically, these may be measured by a method of an example described later.

In particular, a fibrous material may be suitably used for the polyurethane (A). When fibrous, viscidity increase and the like is easy to efficiently (for example, at an early stage) realize or demonstrate.

The polyurethane (A) [resin component (polyurethane) constituting the polyurethane (A) (contained in the polyurethane (A))] is not particularly limited, and for example, any material having a structure polymer diol and a diisocyanate as starting material may be used, and this is not particularly limited.

Furthermore, the method of synthesis thereof is also not particularly limited. For example, a polyurethane urea comprised of a polymer diol, a diisocyanate, and a low molecular weight diamine acting as a chain extender may be used, and a polyurethane urethane comprised of a polymer diol, a diisocyanate, and a low molecular weight diol acting as a chain extender may be used. Furthermore, a polyurethane urea which uses a compound having a hydroxyl group as a chain extender and an amino group in the molecule may be used. It is also preferable that a trifunctional or higher polyfunctional glycol, isocyanate, or the like be used as necessary (to an extent that they do not impede the effects of the present invention).

For the polymer diol, a polyether, polyester diol, polycarbonate diol, or the like is preferable. Also, from the perspective of imparting flexibility and elongation to the molded product (thread or the like), a polyether diols are preferably used.

For example, polyethylene oxide, polyethylene glycol, a derivative of polyethylene glycol, polypropylene glycol, polytetramethylene ether glycol (hereinafter sometimes abbreviated as PTMG), modified PTMG that is a copolymer of tetrahydrofuran (hereinafter sometimes abbreviated as THF) and 3-methyltetrahydrofuran, modified PTMG that is a copolymer of THF and 2-methyltetrahydrofuran, modified PTMG that is a copolymer of THF and 2,3-dimethyl THF, a polyol having a side chain on both sides disclosed in JP 2615131 and the like, a random copolymer in which THF and ethylene oxide and/or propylene oxide are arranged irregularly, and the like are preferably used as the polyether diol. Furthermore, one of these polyether diols may be used, or two or more may be used mixed or copolymerized.

Furthermore, from the perspective of obtaining abrasion resistance and light resistance as a polyurethane elastic fiber, it is preferable to use a butylene adipate, polycaprolactone diol, a polyester diol such as a polyester polyol having a side chain disclosed in JP S61-26612 A and the like, or a polycarbonate diol disclosed in JP H2-289516 B2 and the like.

Furthermore, such polymer diols may be used individually, or two or more may be used mixed or copolymerized.

In terms of the molecular weight of the polymer diol, from the perspective of obtaining elongation, strength, heat resistance, and the like when made into a thread, the number average molecular weight is preferably 1,000 or more and 8,000 or less, more preferably 1,500 or more and 6,000 or less. By using a polyol having a molecular weight in this range, a thread (elastic thread) having excellent elongation, strength, elastic recovery, heat resistance, and the like can be easily obtained.

Next, as the diisocyanate, an aromatic diisocyanate such as diphenylmethane diisocyanate (hereinafter sometimes abbreviated as MDI), tolylene diisocyanate, benzene 1,4-diisocyanate, xylylene diisocyanate, 2,6-naphthalene diisocyanate, and the like are suitable for synthesizing polyurethane having particularly high heat resistance and strength. Moreover, as an alicyclic diisocyanate, for example, methylenebis(cyclohexyl isocyanate), isophorone diisocyanate, methylcyclohexane 2,4-diisocyanate, methylcyclohexane 2,6-diisocyanate, cyclohexane 1,4-diisocyanate, hexahydroxylylene diisocyanate, hexahydrotolylene diisocyanate, octahydro 1,5-naphthalene diisocyanate, and the like are preferable. An alicyclic diisocyanate may be particularly effectively used to suppress yellowing of a polyurethane elastic thread. Also, these diisocyanates may be used alone, or two or more may be used together.

Next, it is preferable that at least one of a low molecular weight diamine and a low molecular weight diol be used for the chain extender used in synthesizing the polyurethane. Note that a substance having both a hydroxyl group and an amino group in one molecule, such as ethanolamine, may also be used.

Examples of a preferable low molecular weight diamine include ethylenediamine, 1,2-propanediamine, 1,3-propanediamine, hexamethylenediamine, p-phenylenediamine, p-xylylenediamine, m-xylylenediamine, p,p′-methylenedianiline, 1,3-cyclohexyldiamine, hexahydrometaphenylenediamine, 2-methylpentamethylenediamine, bis(4-aminophenyl)phosphine oxide, and the like. It is preferable to use one or two or more of these. Ethylenediamine is particularly preferable. By using ethylenediamine, a thread having excellent elongation, elastic recovery, as well as heat resistance can be easily obtained. A triamine compound capable of forming a cross-linked structure in these chain extenders, for example, diethylenetriamine and the like, may be added to an extent that the effect is not lost.

Furthermore, typical examples of a low molecular weight diol include ethylene glycol, 1,3-propanediol, 1,4-butanediol, bishydroxyethoxy benzene, bishydroxyethylene terephthalate, and 1-methyl-1,2-ethanediol. It is preferable to use one or two or more of these. Ethylene glycol, 1,3-propanediol, and 1,4-butanediol are particularly preferable. When these are used, heat resistance further increases as a polyurethane having diol elongation, and a thread having higher strength can be obtained.

It is also preferable to use one or two or more terminal blocking agents mixed in the polyurethane. Preferable examples of terminal blocking agents include: monoamines such as dimethylamine, diisopropylamine, ethylmethylamine, diethylamine, methylpropylamine, isopropylmethylamine, diisopropylamine, butylmethylamine, isobutylmethylamine, isopentylmethylamine, dibutylamine, and diamylamine; monools such as ethanol, propanol, butanol, isopropanol, allyl alcohol, and cyclopentanol; and monoisocyanates such as phenyl isocyanate.

The polyurethane (A) may contain a component (other component) other than the resin component (polyurethane). Such a component may be appropriately selected according to the method of molding the polyurethane (A), an aspect and the like of the molded product, and is not particularly limited.

Examples of another component include metal soaps, surfactants, antioxidants, tertiary amine compounds, crosslinked structure regulators, silicones (for example, silicone oil and modified silicone), fine particles (for example, talc, silica, alumina, zinc oxide, and titanium dioxide), higher aliphatic alcohols, waxes, coloring agents, rosin, dyes, pigments, oils (mineral oil, silicone oil, and the like), inorganic materials and inorganic porous materials (for example bamboo charcoal, wood charcoal, carbon black, porous mud, clay, diatomaceous earth, coconut shell activated carbon, coal-based activated carbon, zeolite, perlite, and the like), catalysts (catalyst components, for example, polyurethane amine catalysts and organometallic catalysts), and the like.

The polyurethane (A) may contain one or two or more other components.

Note that, when the polyurethane (A) contains another component, the proportion of the other component (proportion of the total amount) may be selected from a range of about 50% by mass or less with respect to the entirety of the polyurethane (A), or may be 40% by mass or less (for example, 30% by mass or less, 20% by mass or less, 15% by mass or less, or 10% by mass or less and the like).

Among these, it is preferable that the polyurethane (A) contains a metal soap. By including a metal soap, coupled with the satisfaction of V2/V1 and the like described above, it becomes easy to efficiently impart sufficient viscidity and control increase in viscosity, which is advantageous in terms of moldability (spinnability and the like) and physical properties. The reason for this is not clear, but it is thought that the metal soap, while promoting hydrogen bonding, suppresses the promotion of excessive hydrogen bonding, and as a result, stabilizes association and functions to efficiently adjust viscosity.

Examples of metal soaps include salts of acids and metals.

Examples of acids include octylic acid, lauric acid, stearic acid, palmitic acid, ricinoleic acid, abietic acid, neoabietic acid, d-pimaric acid, iso-d-pimaric acid, podocarpic acid, agathene dicarboxylic acid, benzoic acid, cinnamic acid, p-oxycinnamic acid, diterpenic acid, naphthenic acid, and other organic acids (fatty acids, aromatic carboxylic acids, resin acids, and the like) and the like.

Typical acids include fatty acids [for example, fatty acids having 6 or more carbons (for example, 8 or more, 8 to 40, 8 to 30, and the like), such as octylic acid, lauric acid, stearic acid, palmitic acid, and ricinoleic acid] and the like.

Examples of metals include alkali metals other than sodium and potassium (for example, lithium), alkaline earth metals (for example, beryllium, magnesium, calcium, barium, and the like), and metals other than sodium and potassium such as other metals (for example, aluminum, zinc, cadmium, cobalt, chromium, copper, silver, iron, mercury, manganese, nickel, lead, tin, and titanium), and the like.

Specific examples of metal soaps include octylic acid metal salts (for example, zinc octylate), lauric acid metal salts (for example, calcium laurate, barium laurate, and zinc laurate), stearic acid metal salts (lithium stearate, magnesium stearate, calcium stearate, barium stearate, and zinc stearate), ricinoleic acid metal salts (for example, calcium ricinoleate, barium ricinoleate, and zinc ricinoleate), and the like.

The polyurethane (A) may contain one or two or more other metal soaps.

When the polyurethane (A) contains a metal soap, the proportion of the metal soap may be selected from a range of about, for example, 0.0001% by mass or more with respect to the entirety of the polyurethane (A), may be about 0.0005% by mass or more, preferably 0.001% by mass or more, and more preferably about 0.003% by mass or more, and may be 20% by mass or less [for example, 15% by mass or less (for example, 12% by mass or less), preferably 10% by mass or less (for example, 8% by mass or less), and more preferably 5% by mass or less (for example, 3% by mass or less)].

Specific examples of the proportion of the metal soap include 0.0001 to 10% by mass, preferably 0.001 to 5% by mass, and more preferably 0.003 to 3% by mass, with respect to the entirety of the polyurethane (A).

Furthermore, the polyurethane (A) preferably contains at least one selected from surfactants, antioxidants, tertiary amine compounds, and crosslinked structure regulators. Similarly to metal soaps, such components also, coupled with the satisfaction of V2/V1 and the like described above, facilitate efficient imparting of sufficient viscidity and control increase in viscosity, which is advantageous in terms of moldability (spinnability and the like) and physical properties, perhaps because they are involved in hydrogen bonding, stabilize association, and efficiently function to adjust viscosity.

Examples of surfactants include nonionic (nonionic) surfactants, anionic surfactants, and cationic surfactants.

Examples of nonionic surfactants include polyoxyethylene alkyl ethers, alkyl monoglyceryl ethers, polyoxyethylene alkylamines, fatty acid sorbitan esters, fatty acid diethanolamides, and the like. Among these, a so-called hydrophilic portion (hydrophil) of a surfactant is preferably of an ether type, for example, preferably at least one of an ethylene oxide polymer, a propylene oxide polymer, and a copolymer of ethylene oxide and propylene oxide.

By containing, as a nonionic surfactant, at least one of a terminal-modified derivative of an ethylene oxide polymer, a terminal-modified derivative of a propylene oxide polymer, and a terminal-modified derivative of a copolymer of ethylene oxide and propylene oxide, it is possible to make, for example, antibacterial properties favorable, while increasing spinnability.

A so-called hydrophobic portion (hydrophob) of a surfactant is the above-mentioned terminal-modified structure, and an alkyl group, a phenyl group, or a styrenated phenyl group is preferable, and specific examples of the nonionic surfactant include polyoxyethylene stearyl ether, polyoxyethylene lauryl ether, polyoxyethylene ethyl phenol ether, polyoxyethylene propyl phenol ether, polyoxyethylene styrenated phenyl ether, polyoxyethylene sorbitol tetraoleate, and the like. Polyoxyethylene styrenated phenyl ether is more preferable, and examples include polyoxyethylene oxypropylene tristyrenated phenyl ether, polyoxyethylene oxypropylene distyrenated phenyl ether, polyoxyethylene oxypropylene monostyrenated phenyl ether, polyoxyethylene oxypropylene-2,4,6-tris(α,α-dimethylbenzyl)phenyl ether, polyoxyethylene oxypropylene-2,4-bis(α,α-dimethylbenzyl)phenyl ether, polyoxyethylene oxypropylene-2-mono(α,α-dimethylbenzyl) phenyl ether, polyoxyethylene oxypropylene-4-mono(α,α-dimethylbenzyl) phenyl ether, and the like. Most preferably, the number of added moles of these styrene groups has a distribution, and a mixture thereof is used.

Examples of cationic surfactants include quaternary ammonium salts (quaternary ammonium ions) and the like. Among quaternary ammonium salts, there are differences in antibacterial activity depending on the chain length of the alkyl group in the ammonium ion, and those having strong antibacterial activity are desirable, but from the perspective of suppressing thermal decomposition and the like, it is preferable that the chain type and chain length of the alkyl group or the like be large, that is, an alkyl group or the like having a large carbon number is selected. Also, from a hygiene perspective, it is preferable to contain an antibacterial agent (have antibacterial properties).

Particularly preferable ammonium ions from this perspective are didecyldimethylammonium ions, oleyltrimethylammonium ions, and the like. These are normally supplied by inorganic salts such as chlorides, bromides, and iodides, and organic acid salts such as sulfonates, carboxylates, and phosphates, among which sulfonates and carboxylic acid salts are preferable from the perspective of coloring and stability such as heat resistance.

Specific examples of salts having the structure described above include didecyldimethylammonium trifluoride methylsulfonate, di-n-decyldimethylammonium trifluoromethanesulfonate, di-n-decyldimethylammonium pentafluoroethanesulfonate, n-hexadecyltrimethylammonium trifluoromethanesulfonate and benzyldimethylcocoalkylammonium pentafluoroethanesulfonate.

Examples of antioxidants are not particularly limited and include phenol compounds. The phenol compound may be a hindered phenol compound, and in particular, a hindered phenol may be suitably used.

Examples of the phenol compound (hindered phenol compound or the like) include 3,5-di-t-butyl-4-hydroxy-toluene, n-octadecyl-p-(4′-hydroxy-3′,5′-di-t-butylphenyl)propionate, tetrakis[methylene-3-(3′,5′-di-t-butyl-4′-hydroxyphenyl)propionate]methane, 1,3,5-trimethyl-2,4,6′-tris(3,5-di-t-butyl-4-hydroxybenzyl)benzene, calcium (3,5-di-t-butyl-4-hydroxy-benzyl-monoethyl-phosphate), triethylene glycol-bis[3-(3-t-butyl-5-methyl-4-hydroxyphenyl)propionate], 3,9-bis[1,1-dimethyl-2-{p-(3-t-butyl-4-hydroxy-5-methylphenyl)propionyloxy}ethyl]2,4,8,10-tetraoxaspiro[5,5]undecane, tocopherol, 2,2′-ethylidenebis(4,6-di-t-butylphenol), N,N′-bis[3-(3,5-di-t-butyl-4-hydroxyphenyl)propionyl]hydrazine, 2,2′-oxamidobis[ethyl-3-(3,5-di-t-butyl-4-hydroxyphenyl)propionate], 1,1,3-tris(2-methyl-4-hydroxy-5-t-butylphenyl)butane, ethylene-1,2-bis(3,3-bis[3-t-butyl-4-hydroxyphenyl]butyrate), ethylene-1,2-bis(3-[3-t-butyl-4-hydroxyphenyl]butyrate), 1,1-bis(2-methyl-5-t-butyl-4-hydroxyphenyl)butane, 1,1,3-tris(2-methyl-5-t-butyl-4-hydroxyphenyl)butane, 1,3,5-tris(3′,5′-di-t-butyl-4′-hydroxybenzyl)-S-triazine-2,4,6(1H,3H,5H)-trione, 1,3,5-tris(3′-t-butyl-4′-hydroxy-5-methylbenzyl)-S-triazine-2,4,6(1H,3H,5H)-trione, 1,3,5-tris(4-t-butyl-3-hydroxy-2,6-dimethylbenzyl)-1,3,5-triazine-2,4,6 (1H,3H,5H)-trione, as well as high molecular weight hindered phenol compounds.

As preferable specific examples of the hindered phenol compound having such a high molecular weight, for example, an addition polymer of divinylbenzene and cresol, an addition polymer isobutylene adduct of dicyclopentadiene and cresol, or a polymer of chloromethylstyrene and a compound such as cresol, ethylphenol, and t-butylphenol is used. Here, divinylbenzene and chloromethylstyrene may be p- or m-. Furthermore, cresol, ethylphenol, and t-butylphenol may be any of o-, m-, or p-.

Among these, from perspectives such as stabilizing the viscosity and more readily obtaining favorable spinnability, it is preferable that the compound have a molecular weight of 300 or more, and furthermore, in order to efficiently exhibit high spinning speed, heat resistance during dyeing, resistance to unsaturated fatty acids, and resistance to heavy metals, one or a combination of polymers having a repeating number of 6 to 12, which is an adduct of 1,3,5-tris(4-t-butyl-3-hydroxy-2,6-dimethylbenzyl)-1,3,5-triazine-2,4,6(1H,3H,5H)-trione, triethylene glycol-bis[3-(3-t-butyl-5-methyl-4-hydroxyphenyl)propionate], ethylene-1,2-bis(3,3-bis[3-t-butyl-4-hydroxyphenyl]butylate), divinylbenzene, and p-cresol, may be used. Of these, 1,3,5-tris(4-t-butyl-3-hydroxy-2,6-dimethylbenzyl)-1,3,5-triazine-2,4,6(1H,3H,5H)-trione may be suitably used.

A partially hindered phenol compound is also preferable as the phenol compound. Examples of the partially hindered phenol compound include ethylene-1,2-bis(3,3-bis[3-t-butyl-4-hydroxyphenyl]butyrate) (the following compound) and the like having a structure in which a partially hindered hydroxyphenyl group is covalently bonded to a bis-ester backbone.

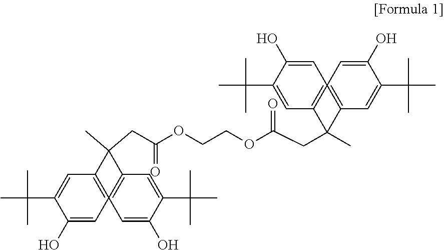

Specifically, a hindered phenol compound having a molecular weight of 1,000 or more is preferable. The molecular weight is not particularly limited other than being a relatively high molecular weight of 1,000 or more, and as preferable specific examples of the hindered phenol compound having such a high molecular weight, an addition polymer of divinylbenzene and cresol, an addition polymer isobutylene adduct of dicyclopentadiene and cresol, or a polymer of chloromethylstyrene and a compound such as cresol, ethylphenol, and t-butylphenol is used. Here, divinylbenzene and chloromethylstyrene may be p- or m-. Furthermore, cresol, ethylphenol, and t-butylphenol may be any of o-, m-, or p-.

Of these, a hindered phenol compound of a polymer derived from cresol is preferable from perspectives such as stabilizing viscosity and obtaining favorable spinnability. Furthermore, in order to efficiently exhibit a high spinning speed, heat resistance during dyeing, resistance to unsaturated fatty acids, and resistance to heavy metals, it is preferable to include a large amount, to an extent, of the high molecular weight hindered phenol compound, but from the perspective of obtaining more favorable basic physical properties as a polyurethane thread, it is preferable that this not be too much.

The tertiary amine compound used in the present invention is not particularly limited so long as it is a compound which has an amino group in the structure, but from the perspective of resistance to chlorine degradation and resistance to yellowing of the polyurethane elastic thread, a compound having only a tertiary amino group in the molecule from among primary to tertiary amino groups is particularly preferable.

A tertiary amine compound having a relatively large molecular weight may be suitably used. In such a tertiary amine compound, the range of the number average molecular weight may be, for example, preferably 2,000 to 10,000, and more preferably 2,000 to 4,000.

More specifically, examples of the tertiary amine compound include a linear high molecular compound having a number average molecular weight of 2,000 or more that is produced by a reaction of t-butyl diethanolamine and methylene-bis-(4-cyclohexyl isocyanate), polyethyleneimine, a high molecular weight compound having a branched structure containing a primary amino group, a secondary amino group, and a tertiary amino group in the molecular framework, or the like.

Examples of a crosslinked structure regulator include monoamines, diamines, and the like. More specifically, examples include monoamines (for example, dimethylamine, diethylamine, cyclohexylamine, and the like), diamines (for example, ethylenediamine, 1,2-propanediamine, 1,3-propanediamine, hexamethylenediamine, p-phenylenediamine, p-xylylenediamine, m-xylylenediamine, 1,3-cyclohexyldiamine, hexahydrometaphenylenediamine, 2-methylpentamethylenediamine), and the like. It is particularly preferable that a mix of monoamine and a diamine be used.

When the polyurethane (A) contains a surfactant, the proportion of the surfactant may be selected from a range of about, for example, 0.0001% by mass or more with respect to the entirety of the polyurethane (A), may be about 0.0005% by mass or more, preferably 0.001% by mass or more, and more preferably about 0.003% by mass or more, and may be 20% by mass or less [for example, 15% by mass or less (for example, 12% by mass or less), preferably 10% by mass or less (for example, 8% by mass or less), and more preferably 5% by mass or less (for example, 3% by mass or less)].

Specific examples of the proportion of the surfactant include 0.0001 to 10% by mass, preferably 0.001 to 5% by mass, and more preferably 0.003 to 3% by mass or the like, with respect to the entirety of the polyurethane (A).

When the polyurethane (A) contains an antioxidant, the proportion of the antioxidant may be selected from a range of about, for example, 0.0001% by mass or more with respect to the entirety of the polyurethane (A), may be about 0.0005% by mass or more, preferably 0.001% by mass or more, and more preferably about 0.002% by mass or more, and may be 20% by mass or less [for example, 15% by mass or less (for example, 12% by mass or less), preferably 10% by mass or less (for example, 8% by mass or less), and more preferably 7% by mass or less (for example, 5% by mass or less)].

Specific examples of the proportion of the antioxidant include 0.0001 to 10% by mass, preferably 0.001 to 7% by mass, and more preferably 0.002 to 5% by mass or the like, with respect to the entirety of the polyurethane (A).

Note that from the perspective of moldability (for example, spinnability), physical properties (strength, yellow resistance, durability, and the like), and the like, a proportion of decomposition products of the antioxidant (phenol compounds and the like) in the polyurethane (A) may be 1% by mass or less with respect to the entirety of the polyurethane (A), preferably 0.5% by mass or less.

When the polyurethane (A) contains a tertiary amine compound, the proportion of the tertiary amine compound may be selected from a range of about, for example, about 0.01% by mass or more with respect to the entirety of the polyurethane (A), may be about 0.05% by mass or more, preferably 0.1% by mass or more, and more preferably 0.2% by mass or more, and may be 30% by mass or less [for example, 20% by mass or less (for example, 15% by mass or less), preferably 12% by mass or less (for example, 10% by mass or less), and more preferably 7% by mass or less (for example, 5% by mass or less)].

Specific examples of the proportion of the tertiary amine compound include 0.01 to 20% by mass, preferably 0.1 to 10% by mass, and more preferably 0.2 to 5% by mass or the like, with respect to the entirety of the polyurethane (A).

Note that from the perspective of moldability (for example, spinnability), physical properties (strength, yellow resistance, durability, and the like), and the like, a proportion of decomposition products of the tertiary amine compound in the polyurethane (A) may be 1% by mass or less, preferably 0.5% by mass or less, with respect to the entirety of the polyurethane (A).

When the polyurethane (A) contains a crosslinked structure regulator, the proportion of the crosslinked structure regulator may be selected from a range of about, for example, 0.0001% by mass or more with respect to the entirety of the polyurethane (A), may be about 0.0005% by mass or more, preferably 0.001% by mass or more, and more preferably about 0.002% by mass or more, and may be 20% by mass or less [for example, 15% by mass or less (for example, 12% by mass or less), preferably 10% by mass or less (for example, 8% by mass or less), and more preferably 5% by mass or less (for example, 2% by mass or less)].

Specific examples of the proportion of the crosslinked structure regulator include 0.0001 to 10% by mass, preferably 0.001 to 5% by mass, and more preferably 0.002 to 2% by mass or the like, with respect to the entirety of the polyurethane (A).

The polyurethane (A) is not particularly limited, and a commercially available product (distributed product) may be used, or a product manufactured or molded by a conventional method may be used.

The derived manufacturing method or molding method used for such polyurethane (A) is also not particularly limited and may be appropriately selected according to the type, aspect, and the like of the molded product. For example, the fibrous polyurethane (A) may be obtained by a conventional spinning method (for example, a melt spinning method, a wet spinning method, a dry spinning method, or the like).

In addition, the polyurethane (A) may be an unused product or a used product.

Furthermore, the polyurethane (A) may be an item left or stored without being used (sold, used for various purposes and the like) after manufacturing (for example, left or stored for one month or more (for example, six months or more, one year or more and the like)) {for example, the fiber itself, a thread roll [for example, a warping roll (beam), which is an intermediate product of knitting and weaving processing], processed thread, or the like}, or the like, or may be molding waste [for example, waste (not formed into a thread roll) cut off when passing through various spinning methods to obtain a thread roll, or the like]. Moreover, this may be a used product (post-consumer product).

Polyurethane may be efficiently used [reused (recycled)] by using such left or stored items (for example, items that are disposed of due to excess inventory and the like), molding waste, used items, and the like.

Note that when polyurethane that satisfies properties such as those described above is a commercially available product, it is sufficient to select one that satisfies the properties such as described above, and when such is a manufactured product, one which is manufactured to satisfy the properties such as described above may be used.

For example, the viscidity (ease of thickening) of polyurethane is recognized to be influenced by association as described above and thus can be efficiently adjusted by adjusting the ease of association. To give a specific example, when it comes to the resin component (polyurethane) itself, the ease of association may be efficiently adjusted according to the degree of progress of the reaction [for example, using polyurethane for which reaction of polymerization components has progressed sufficiently (which in turn tends to generate crystal nuclei that may become association nuclei), and the like], and such ease of association is efficiently adjusted by the presence or absence of high molecular weight components such as described above, compounding of other components (and the amount thereof), and the like.

Note that the polyurethane (A) containing other components may be manufactured by adding or compounding to the base resin component (polyurethane) using a conventional method, or a product in which other components are already compounded (includes other components) in a commercially available product, recycled product, or the like, may be used.

### [Applications of Additives]

The additive of the present invention is comprised of the polyurethane (A).

A target of such an additive (addition target or compounding target) is not limited, but in particular, it may be a dope. That is, the additive of the present invention may be an additive for a dope (an agent for adding to a dope).

Furthermore, as described above, the additive (polyurethane (A)) realizes an increase or adjustment of viscidity (maintains viscidity or suppresses decrease in viscidity) and also may improve moldability (spinnability) and physical properties.

Therefore, the additive (polyurethane (A)) may be used for applications corresponding to such functions. For example, the additive (polyurethane (A)) may be a viscidity (viscosity) modifier [viscidity (viscosity) control agent, viscidity (viscosity) increasing agent, thickener, or viscidity (viscosity) maintaining agent], moldability (spinnability and the like) improving agent (increasing agent), and/or physical property (for example, at least one physical property selected from strength, elongation, heat resistance, and durability) improving agent (increasing agent), or the like (may be used for applications such as these).

In particular, the additive (polyurethane (A)) is suitable for use as a dope (furthermore, for improvement of viscidity and physical properties such as described above), so dope applications will be described in detail below.

### <Dope and the Like>

A dope is a liquid (liquid substance, substance in liquid state) that contains a resin (resin component) and need not contain a solvent (bulk dope), but normally may contain a resin and a solvent {in particular, the dope may be a solution [or dispersion; a solution (or dispersion) in which at least a resin is dissolved (or dispersed)] containing a resin}.

Note that since the polyurethane (A) is also a resin, and when compounded with the dope, becomes a resin constituting the dope.

The resin components (polyurethane and the like) constituting such a dope (contained in the dope) may be comprised only of the polyurethane (A), or may contain the polyurethane (A) and another resin (B) (a resin component different from the polyurethane (A)).

That is, the dope may be a dope containing only the polyurethane (A) as a resin, or may be a dope containing the polyurethane (A) and the resin (B) as resins.

Note that the dope containing the polyurethane (A) and the resin (B) may be obtained by mixing the polyurethane (A) and the resin (B), or may be obtained by mixing the polyurethane (A) into a system (dope) containing the resin (B) in advance.

In particular, the polyurethane (A) is preferably used in combination with the resin (B) in view of functions such as controlling viscidity and improving moldability (spinnability) and physical properties, and the like.

The resin (B) may be either non-polyurethane or polyurethane, but in view of the fact that the additive (polyurethane (A)) is polyurethane, it is preferable that it contain at least polyurethane. In other words, the dope may be a polyurethane dope (a dope containing polyurethane as the resin (B)).

Such polyurethanes (sometimes referred to as polyurethane acting as the resin (B), the polyurethane (B), and the like) are not particularly limited, but include, for example, a polyurethane similar to those described in the section of the polyurethane (A). Preferable aspects of the polyurethane (B) and the like are also similar to those described for the polyurethane (A).

In particular, the polyurethane (B) and the polyurethane (A) may be polyurethanes of the same type or same class (for example, both the polyurethane (A) and (B) being polyurethane ureas, or the like).

When the dope contains the resin (B), a proportion of the polyurethane (A) relative to the total amount of the polyurethane (A) and the resin (B) (for example, the polyurethane (B)) may be appropriately selected according to what is to be increased or improved [for example, moldability (spinnability and the like) and physical properties (strength, elongation, heat resistance, and the like)], the degree thereof, or the like, and may be 0.1% by mass or more (for example, 0.5% by mass or more), preferably 1% by mass or more (for example, 2% by mass or more), and more preferably 3% by mass or more (for example, 5% by mass or more), or may be 8% by mass or more (for example, 10% by mass or more, 12% by mass or more, 15% by mass or 20% by mass or more, 25% by mass or more, 30% by mass or more, 40% by mass or more, 50% by mass or more, 60% by mass or more, 70% by mass or more, 80% by mass or more, 90% by mass or more, or 95% by mass or more), or the like.

A proportion (upper limit value of the proportion) of the polyurethane (A) to the total amount of the polyurethane (A) and the resin (B) (for example, the polyurethane (B)) may be selected from a range of about 99.9% by mass or less (for example, 99.5% by mass or less), may be 99% by mass or less (for example, 98% by mass or less), preferably 97% by mass or less (for example, 95% by mass or less), or may be 90% by mass or less (for example, 88% by mass or less, 85% by mass or less, 80% by mass or less, 75% by mass or less, 70% by mass or less, 60% by mass or less, 50% by mass or less, 45% by mass or less, 40% by mass or less, 35% by mass or less, or 30% by mass or less) or the like.

Specifically, examples of the proportion of the polyurethane (A) to the total amount of the polyurethane (A) and the resin (B) (for example, the polyurethane (B)) include 0.1 to 99.9% by mass (for example, 0.5 to 99% by mass), 1 to 99% by mass (for example, 3 to 97% by mass), 5 to 95% by mass (for example, 10 to 90% by mass), 1 to 50% by mass, 3 to 40% by mass, 50 to 99% by mass, 60 to 95% by mass, or the like.

Note that the proportion of the polyurethane (A) to the total amount 100 of the polyurethane (A) and the resin (B) (for example, the polyurethane (B)) may be appropriately selected so as to achieve the viscosity and viscosity ratio described later.

A molecular weight of the resin constituting the dope also depends on the type of the resin (B) (for example, the polyurethane (B)), the mixing proportion with the polyurethane (A), and the like, but, for example, the number average molecular weight of the resin [for example, the polyurethane (A) alone or a mixed resin ( ) of the polyurethane (A) and the resin (B) (polyurethane (B) or the like)] may be selected from a range of about 2,000 or more (for example, 3,000 or more or 4,000 or more), may be, for example, about 5,000 or more (for example, 6,000 or more or 7,000 or more), preferably 8,000 or more (for example, 9,000 or more), and more preferably 10,000 or more (for example, 11,000 or more, 12,000 or more, 13,000 or more, or 14,000 or more), or may be about 15,000 or more (for example, 16,000 or more, 17,000 or more, 18,000 or more, 19,000 or more, 20,000 or more, 21,000 or more, 22,000 or more, 23,000 or more, 24,000 or more, 25,000 or more, 26,000 or more, 27,000 or more, or 28,000 or more).

Note that the (upper limit value of the) number average molecular weight of the resin constituting the dope is not limited, but may be selected from a range of about 2,000,000 or less (for example, 1,500,000 or less or 1,200,000 or less), may be, for example, 1,000,000 or less (for example, 800,000 or less or 700,000 or less), preferably 500,000 or less (for example, 300,000 or less), and more preferably 200,000 or less (for example, 180,000 or less, 150,000 or less, or 120,000 or less), or may be about 100,000 or less (for example, 90,000 or less, 80,000 or less, 70,000 or less, 60,000 or less, 55,000 or less, 50,000 or less, 45,000 or less, 40,000 or less, or 35,000 or less).

Specific examples of the number average molecular weight of the resin constituting the dope include 10,000 to 300,000, 20,000 to 200,000, and 30,000 to 150,000, or the like.

In particular, the resin constituting the dope may have peaks owing to a high molecular weight component in GPC (GPC chart) [for example, generally, peaks in a molecular weight (number average molecular weight) region of about 1 million or more (for example, 1 million to 50 million, 1 million to 30 million, 2 million to 15 million, or 3 million to 10 million)].

Note that such peaks derived from the high molecular weight component may be generated in the system (polymerization within the dope), or may derive from a high molecular weight component contained in the polyurethane (A). Normally, by using the polyurethane (A) containing a high molecular weight component, a peak derived from the high molecular weight component may be found even in the resin constituting the dope.

When there is a molecular weight range or peak derived from a high molecular weight component as described above, for example, this is likely to be advantageous in terms of moldability (spinnability and the like) and physical properties.

The resin (B) may be contained in the dope from the raw material (monomer) stage so long as it can constitute the resin together with the polyurethane (A) in the dope (while being used as a dope). For example, a dope containing the polyurethane (A) and the resin (B) may be obtained by starting with a dope containing the polyurethane (A) and a raw material of the resin (B) (for example, a monomer that is a raw material of polyurethane) and polymerization proceeding in the system (in the dope).

The dope may contain other components (components other than resin). Examples of such other components depend on the resin constituting the dope, the application of the dope, and the like, but include components described above and the like, such as metal soaps, surfactants, antioxidants, tertiary amine compounds, crosslinked structure regulators, silicones (for example, silicone oil and modified silicone), fine particles (for example, talc, silica, alumina, zinc oxide, and titanium dioxide), higher aliphatic alcohols, waxes, coloring agents, rosin, dyes, pigments, oils (mineral oil, silicone oil, and the like), inorganic materials and inorganic porous materials (for example bamboo charcoal, wood charcoal, carbon black, porous mud, clay, diatomaceous earth, coconut shell activated carbon, coal-based activated carbon, zeolite, perlite, and the like), catalysts (catalyst components, for example, polyurethane amine catalysts and organometallic catalysts), and the like.

Note that such other components may be contained in the polyurethane (A) in advance, may be added to the dope separately, or may be a combination of those contained in the polyurethane (A) and those added separately.

Preferable aspects of other components (preferable components and proportions at which such are contained in the resin) and the like are also similar to those described for the polyurethane (A).

When the dope contains another component, a proportion of the other component (proportion of the total amount), with respect to the total amount of the resin and the other component (for example: the polyurethane (A) containing another component; the total amount of the polyurethane (A) containing another component, and the resin (B); the total amount of the polyurethane (A), which may contain another component, the resin (B), and another component separately compounded into the dope; and the like), may be, for example, selected from a range of about 50% by mass or less, or may be 40% by mass or less (for example, 30% by mass or less, 20% by mass or less, 15% by mass or less, 10% by mass or less, or the like).

When the dope contains a metal soap, a proportion of the metal soap with respect to the total amount of the resin and the metal soap (for example: the polyurethane (A) containing the metal soap; the total amount of the polyurethane (A) containing the metal soap, and the resin (B); the total amount of the polyurethane (A), which may contain the metal soap, and the resin (B) and a metal soap separately compounded into the dope; and the like), may be selected from a range of about, for example, 0.0001% by mass or more, may be about 0.0005% by mass or more, preferably 0.001% by mass or more, and more preferably 0.003% by mass or more, and may be 20% by mass or less [for example, 15% by mass or less (for example, 12% by mass or less), preferably 10% by mass or less (for example, 8% by mass or less), and more preferably 5% by mass or less (for example, 3% by mass or less)].

Specific examples of the proportion of the metal soap include 0.0001 to 10% by mass, preferably 0.001 to 5% by mass, and more preferably 0.003 to 3% by mass or the like, with respect to the total amount of the resin and metal soap.

When the dope contains a surfactant, a proportion of the surfactant with respect to the total amount of the resin and the surfactant (for example: the polyurethane (A) containing the surfactant; the total amount of the polyurethane (A) containing the surfactant, and the resin (B); the total amount of the polyurethane (A), which may contain the surfactant, and the resin (B) and a surfactant separately compounded into the dope; and the like), may be selected from a range of about, for example, 0.0001% by mass or more, may be about 0.0005% by mass or more, preferably 0.001% by mass or more, and more preferably 0.003% by mass or more, and may be 20% by mass or less [for example, 15% by mass or less (for example, 12% by mass or less), preferably 10% by mass or less (for example, 8% by mass or less), and more preferably 5% by mass or less (for example, 3% by mass or less)].

Specific examples of the proportion of the surfactant include 0.0001 to 10% by mass, preferably 0.001 to 5% by mass, and more preferably 0.003 to 3% by mass or the like, with respect to the total amount of the resin and surfactant.

When the dope contains an antioxidant, a proportion of the antioxidant with respect to the total amount of the resin and the antioxidant (for example: the polyurethane (A) containing the antioxidant; the total amount of the polyurethane (A) containing the antioxidant, and the resin (B); the total amount of the polyurethane (A), which may contain the antioxidant, and the resin (B) and an antioxidant separately compounded into the dope; and the like), may be selected from a range of about, for example, 0.0001% by mass or more, may be about 0.0005% by mass or more, preferably 0.001% by mass or more, and more preferably 0.002% by mass or more, and may be 20% by mass or less [for example, 15% by mass or less (for example, 12% by mass or less), preferably 10% by mass or less (for example, 8% by mass or less), and more preferably 7% by mass or less (for example, 5% by mass or less)].

Specific examples of the proportion of the antioxidant include 0.0001 to 10% by mass, preferably 0.001 to 7% by mass, and more preferably 0.002 to 5% by mass or the like, with respect to the total amount of the resin and the antioxidant.

Note that from the perspective of moldability (for example, spinnability), physical properties (strength, yellow resistance, durability, and the like), and the like, a proportion of decomposition products of the antioxidant (phenol compounds and the like) may be 1% by mass or less with respect to the total amount of the resin and decomposition products of the antioxidant, preferably 0.5% by mass or less.

When the dope contains a tertiary amine compound, a proportion of the tertiary amine compound with respect to the total amount of the resin and the tertiary amine compound (for example: the polyurethane (A) containing the tertiary amine compound; the total amount of the polyurethane (A) containing the tertiary amine compound, and the resin (B); the total amount of the polyurethane (A), which may contain the tertiary amine compound, the resin (B), and a tertiary amine compound separately compounded into the dope; and the like), may be selected from a range of about, for example, 0.01% by mass or more, may be about 0.05% by mass or more, preferably 0.1% by mass or more, and more preferably 0.2% by mass or more, and may be 30% by mass or less [for example, 20% by mass or less (for example, 15% by mass or less), preferably 12% by mass or less (for example, 10% by mass or less), and more preferably 7% by mass or less (for example, 5% by mass or less)].

Specific examples of the proportion of the tertiary amine compound include 0.01 to 20% by mass, preferably 0.1 to 10% by mass, and more preferably 0.2 to 5% by mass or the like, with respect to the total amount of the resin and the tertiary amine compound.

Note that from the perspective of moldability (for example, spinnability), physical properties (strength, yellow resistance, durability, and the like), and the like, a proportion of decomposition products of the tertiary amine compound may be 1% by mass or less, preferably 0.5% by mass or less, with respect to the total amount of the resin and decomposition products of the tertiary amine compound.

When the dope contains a crosslinked structure regulator, a proportion of the crosslinked structure regulator with respect to the total amount of the resin and the crosslinked structure regulator (for example: the polyurethane (A) containing the crosslinked structure regulator; the total amount of the polyurethane (A) containing the crosslinked structure regulator, and the resin (B); the total amount of the polyurethane (A), which may contain the crosslinked structure regulator, and the resin (B) and a crosslinked structure regulator separately compounded into the dope; and the like), may be selected from a range of about, for example, 0.0001% by mass or more, may be about 0.0005% by mass or more, preferably 0.001% by mass or more, and more preferably 0.002% by mass or more, and may be 20% by mass or less [for example, 15% by mass or less (for example, 12% by mass or less), preferably 10% by mass or less (for example, 8% by mass or less), and more preferably 5% by mass or less (for example, 2% by mass or less)].

Specific examples of the proportion of the crosslinked structure regulator include 0.0001 to 10% by mass, preferably 0.001 to 5% by mass, and more preferably 0.002 to 2% by mass or the like, with respect to the total amount of the resin and the crosslinked structure regulator.

The dope may contain a solvent.

The solvent depends on the type of the resin (B), the molding method, the aspect of the molded product, and the like, but examples include organic solvents {for example, amide solvents [for example, chain aliphatic amides such as N,N-dimethylformamide and N,N-dimethylacetamide (DMAc); and cyclic aliphatic amides such as N-methyl-2-pyrrolidone and N-vinylpyrrolidone], halogen solvents (for example 1,1-difluorotetrachloroethane, dichloromethane, and the like), ether solvents (for example, cyclic ethers such as 1,4-dioxane, 1,3-dioxolane, and tetrahydrofuran), ester solvents (for example, fatty acid esters such as ethyl acetate), ketone solvents (for example, chain ketones such as acetone and methyl ethyl ketone; and cyclic ketones such as cyclohexanone), nitrile solvents (for example, acetonitrile and the like), sulfur solvents (for example, sulfonic solvents such as diethyl sulfone; and sulfoxide solvents such as dimethyl sulfoxide), alcohol solvents (for example alkanols such as methanol, ethanol, and isopropanol), amine oxide solvents (for example, N-methylmorpholine N-oxide)}, water, and the like.

A solvent may be used alone, or two or more may be used in combination.

Among these, polar solvents (for example, aprotic polar solvents or protic polar solvents, particularly aprotic polar solvents) such as amide solvents (for example, DMAc, dimethylformamide, dimethyl sulfoxide, vinylpyrrolidone, and the like) and sulfur solvents (for example, dimethyl sulfoxide, and the like) may be suitably used.

An SP value [(cal/cm)^{1/2}] of such a solvent (for example, a polar solvent) may be about, for example, 5 to 16, preferably 6 to 15, and more preferably 6.5 to 14 (for example, 7 to 13).

Note that the SP value may be, for example, a Hansen solubility parameter (Hansen method). Such a Hansen solubility parameter may be measured or calculated by, for example, the Hansen sphere method.

In a dope containing a solvent, a solid content (or non-solvent components, resins, other components, and the like) concentration depends on an aspect of molding and the like, but may be, for example, 1 to 90% by mass (for example, 3 to 95% by mass), preferably 5 to 80% by mass (for example, 10 to 70% by mass), and more preferably 15 to 60% by mass (for example, 20 to 50% by mass).

In particular, when the dope is used in a spinning solution (solution for spinning), the solid content concentration may be about, for example, 5 to 80% by mass, preferably 8 to 70% by mass, and more preferably 10 to 60% by mass (for example, 15 to 55% by mass, 20 to 50% by mass, 25 to 45% by mass, 35 to 55% by mass, or 30 to 60% by mass).

In the dope (for example, a dope containing a solvent), a proportion of the polyurethane (A) may be set to about, for example, 0.1% by mass or more (for example, 0.5% by mass or more), preferably 1% by mass or more (for example, 2% by mass or more), and more preferably 3% by mass or more (for example, 5% by mass or more), or may be about 8% by mass or more (for example, 10% by mass or more, 12% by mass or more, 15% by mass or more, 20% by mass or more, 25% by mass or more, 30% by mass or more, 40% by mass or more, or 50% by mass or more) or the like.

In the dope, the upper limit value of the proportion of the polyurethane (A) may be appropriately selected according to whether a solvent is included or not or the like. In particular, in the dope containing a solvent, the proportion (upper limit value of the proportion) of the polyurethane (A) can be selected from a range of about 99% by mass or less (for example, 97% by mass or less) or can also be set to be 95% by mass or less (for example, 90% by mass or less), preferably 85% by mass or less (for example, 80% by mass or less), and more preferably 75% by mass or less (for example, 70% by mass or less, 65% by mass or less, 60% by mass or less, 55% by mass or less, 50% by mass or less, 45% by mass or less, 40% by mass or less, or 35% by mass or less), or the like.

The viscosity of the dope also depends on the form of molding (for example, whether used as a spinning solution), solid content concentration (for example, whether the concentration is suitable in a spinning solution such as described above), and the like, but, for example, at 40° C., the viscosity of the dope may be selected from a range of about 10 poise (=1 Pa·s=1,000 mPa·s) or more, may be about 100 poise or more (for example, 200 poise or more, 300 poise or more, or 400 poise or more), preferably 500 poise or more (for example, 600 poise or more, 700 poise or more, or 800 poise or more), and more preferably 1,000 poise or more (for example, 1,100 poise or more or 1,200 poise or more), and can be set to be 1,300 poise or more (for example, 1,400 poise or more, 1,500 poise or more, 1,600 poise or more, 1,700 poise or more, 1,750 poise or more, 1,800 poise or more, 1,900 poise or more, 2,000 poise or more, 2,100 poise or more, 2,200 poise or more, 2,300 poise or more, 2,400 poise or more, 2,500 poise or more, 2,600 poise or more, 2,700 poise or more, 2,800 poise or more, 2,900 poise or more, 3,000 poise or more, 3,100 poise or more, 3,200 poise or more, 3,300 poise or more, 3,400 poise or more, 3,500 poise or more, 3,600 poise or more, 3,700 poise or more, 3,800 poise or more, 3,900 poise or more, or 4,000 poise or more) or the like.

The (upper limit value of the) viscosity of the dope is not limited, but, at 40° C., may be selected from a range of about 100,000 poise or less, may be about 80,000 poise or less (for example, 60,000 poise or less, 50,000 poise or less, or 40,000 poise or less), preferably 30,000 poise or less (for example, 20,000 poise or less, 15,000 poise or less, or 12,000 poise or less), and more preferably 10,000 poise or less (for example, 9,000 poise or less, or 8,000 poise or less), or can be set to 7,000 poise or less (for example, 6,500 poise or less, 6,000 poise or less, 5,500 poise or less, 5,000 poise or less, 4,500 poise or less, 4,400 poise or less, 4,300 poise or less, 4,200 poise or less, 4,100 poise or less, 4,000 poise or less, 3,900 poise or less, 3,800 poise or less, 3,700 poise or less, 3,600 poise or less, 3,500 poise or less, 3,400 poise or less, 3,300 poise or less, 3,200 poise or less, 3,100 poise or less, 3,000 poise or less, 2,900 poise or less, 2,800 poise or less, 2,700 poise or less, 2,600 poise or less, 2,500 poise or less, 2,400 poise or less, 2,300 poise or less, 2,200 poise or less, 2,100 poise or less, 2,000 poise or less, 1,900 poise or less, 1,850 poise or less, or 1,800 poise or less) or the like.

The viscosity of the dope may change over time, but when used as a dope, the viscosity may be maintained (kept) so as to be a viscosity within a range such as described above.

Furthermore, the viscosity of the dope may change over time, but the change thereof is preferably small and more preferably increases over time.

For example, at 40° C., the proportion (ratio, rate, viscosity ratio, viscosity after 24 hours/initial viscosity, V2/V1) of the viscosity (initial viscosity, V1) of when preparing the dope (for example, when the polyurethane (A) is dissolved (mixed)) and the viscosity 24 hours (left to stand) after preparation [for example, dissolving (mixing)] (viscosity after 24 hours, V2) can be selected from a range of 0.7 or more (for example, 0.75 or more), and may satisfy, for example, 0.8 or more (for example, 0.85 or more or 0.9 or more), preferably 0.95 or more (for example, 0.98 or more or 0.99 or more), and more preferably 1 or more (for example, more than 1, 1.001 or more, or 1.005 or more), particularly may satisfy 1.01 or more (for example, 1.02 or more, 1.03 or more, 1.04 or more, 1.05 or more, 1.06 or more), or may satisfy 1.08 or more (for example, 1.1 or more, 1.15 or more, 1.2 or more, 1.25 or more, 1.3 or more, 1.35 or more, 1.4 or more, 1.45 or more, 1.5 or more, 1.55 or more, 1.6 or more, 1.7 or more, 1.8 or more, 1.9 or more, or the like).

The (upper limit value of the) above viscosity after 24 hours/initial viscosity (V2/V1) is not particularly limited, and can be selected from a range of about 20 or less (for example, 15 or less), for example, can be set to be about 10 or less (for example, 8 or less, 7 or less, or 6 or less), preferably 5 or less (for example, 4.5 or less, or 4 or less), or more preferably 3.5 or less (for example, 3.3 or less, 3.2 or less, 3.1 or less, 3 or less, 2.9 or less, 2.8 or less, 2.7 or less, 2.6 or less, 2.5 or less, 2.4 or less, 2.3 or less, 2.2 or less, 2.1 or less, 2 or less, 1.9 or less, 1.8 or less, 1.7 or less, 1.6 or less, 1.5 or less, 1.4 or less, or 1.3 or less).

Specific examples of the viscosity after 24 hours/initial viscosity (V2/V1) include 0.7 to 10, 1 to 5, 1.01 to 4, 1.03 to 3.5, 1.1 to 3.3, 1.2 to 3.5, 1.05 to 3, 1.05 to 1.2, and the like.

When in such a range, viscosity reduction can be efficiently suppressed, or viscosity can be increased appropriately, and viscosities that are advantageous in terms of moldability (spinnability and the like) and physical properties can be easily configured.

Note that the viscosities described above (V1 and V2) in the dope can be measured by: setting a state wherein solid content (the resin polyurethane (A), the resin (B), and the like) are sufficiently dissolved (dispersed) at 40° C. (initial viscosity (V1)) to be a starting point; setting the point in time when 24 hours has elapsed after this starting point (viscosity after 24 hours (V2)) to be the end point; and using a viscometer (for example, a falling-ball viscometer) (for example, according to the method of ASTM D1343-69) and, for example, can be measured according to the method described below.

The dope can be manufactured by mixing components that constitute the dope.

In such mixing, the method for mixing (adding) the polyurethane (A) is not particularly limited. For example, a dope containing a solvent and the resin (B) may be obtained by mixing the polyurethane (A) into a system containing the resin (B) (or raw materials thereof) and a solvent, or may be obtained by mixing the polyurethane (A), the resin (B), and the solvent at once.

Note that when mixing, heating and stirring may be performed as appropriate for purposes such as promoting melting (dissolution) or dispersion of the polyurethane (A), and various components may be mixed thereinto.

The dope can be used for applications according to the form of the molded product and the like, and may be suitably used, for example, in the manufacture of fibers (threads).

Specifically, fibers (threads) can be manufactured by spinning the dope.

The fibers contain the polyurethane (A) as a resin, and typically, may be polyurethane fibers (threads) {for example, polyurethane fibers (for example, polyurethane elastic fibers) containing polyurethane [for example, mainly containing the polyurethane (A) or mainly containing the polyurethane (A) and the polyurethane (B)] as the main resin}.

The spinning method is not particularly limited as long as a dope is used, and for example, a solution spinning method (for example, a dry spinning method) may be suitably used.

In such a spinning method (for example, dry spinning method), known or conventionally used spinning conditions and the like can be used, and these are not particularly limited. Note that, treatments (or surface treatment) may be performed (conventional additives may be applied, attached, or contained) onto the obtained fibers (thread) using conventional additives (fiber treatment agents or finishing agents, for example, the components and the like described above such as silicones, oils, inorganic materials, and inorganic porous materials) at an appropriate timing (for example, when winding and the like).

By using the dope (or polyurethane (A)), a molded product [fiber (thread) or the like] can be obtained. Thus, the present invention also includes such molded products.

Such molded products may generally reflect the form of the polyurethane (A) or dope. For example, when the polyurethane (A) or dope contains a high molecular weight component or other component as described above, the molded product may also contain such components.

### EXAMPLES

Hereinafter, the present invention will be described in more detail by taking examples, but the present invention is not limited by the examples whatsoever.

First, measurement/evaluation methods of each of physical properties and the like will be described. Note that unless otherwise specified, measurements were performed under the conditions of 23° C. and relative humidity of 60%.

### <Viscosity>

Viscosity was measured at 40° C. using a model DV-8 falling-ball viscometer (Duratech Corp. (Waynesboro, VA)) according to the method of ASTM D1343-69. Note that a viscometer tube having an inner diameter of 31.4 (±0.2) mm was used.

### <Viscosity Ratio of Initial Viscosity and Viscosity 24 Hours Later in 20% by Mass DMAc Solution>

After a sample (polyurethane, polyurethane (A)) was thoroughly dried (for 8 hours in a vacuum dryer at about 40° C. and a reduced pressure of 1 kilopascal or less), the sample was mixed into N,N-dimethylacetamide (DMAc) such that the concentration thereof reaches 20% by mass, and stirred for 4 hours at 23° C. (ambient temperature) to prepare a 20% by mass DMAc solution.

Note that a cylindrical container was used for stirring, and a helical ribbon stirring blade covering 85% of the projected outer surface of the bottom of the container was used.

After the obtained 20% by mass DMAc solution was left to stand for 2 hours at 40° C. (the temperature of a thermostatic bath of a falling-ball viscometer) to stabilize [dissolved (or dispersed)], the initial viscosity at 40° C. (the viscosity after the solution is left to stand for 2 hours to stabilize) and after the solution was left to stand for 24 hours (after additional 24 hours have elapsed) were respectively measured by the method described in <Viscosity> described above.

Then, a viscosity ratio (initial viscosity/viscosity after 24 hours) was calculated from the obtained initial viscosity and viscosity after 24 hours.

### <Viscosity Ratio of Initial Viscosity and Viscosity 24 Hours Later of Dope>

After a dope (spinning solution) was left to stand for 2 hours at 40° C. (the temperature of a thermostatic bath of a falling-ball viscometer) to stabilize, the initial viscosity at 40° C. (the viscosity after the solution is left to stand for 2 hours to stabilize) and after the solution was left to stand for 24 hours (after additional 24 hours have elapsed) were respectively measured by the method described in <Viscosity> described above.

Then, a viscosity ratio (initial viscosity/viscosity after 24 hours) was calculated from the initial viscosity and viscosity after 24 hours.

### <Molecular Weight>

Molecular weight measurement by GPC was performed under the following conditions.
Column: Two SHODEX KF-806M columns manufactured by Showa Denko K.K.
Solvent: N,N-dimethylacetamide (DMAc) 1 ml/min
Temperature: 40° C.
Detector: Differential refractometer (RI detector)
Reference material: Polystyrene

### <Amino Group Concentration>

A 20% by mass DMAc solution of the sample (polyurethane, polyurethane (A)) prepared by the method described above was diluted using DMAc to prepare a 2% by mass DMAc solution, and the total amount (X) (meq/kg) of terminal groups (the sum of terminal groups derived from primary amines and terminal groups derived from secondary amines) was measured for the DMAc solution at room temperature (18 to 28° C.), by performing potentiometric titration with p-toluenesulfonic acid (0.01 N) using an automatic titrator (COM-1760) manufactured by Hiranuma Co., Ltd.

A 20% by mass DMAc solution of the sample (polyurethane, polyurethane (A)) prepared by the method described above was diluted using DMAc to prepare a 2% by mass DMAc solution, and salicylic aldehyde (20% by mass isopropyl alcohol solution) was added to the DMAc solution to block terminal groups derived from primary amines (to be reacted with terminal groups derived from primary amines), and then potentiometric titration with p-toluenesulfonic acid (0.01 N) was performed using an automatic titrator (COM-1760) manufactured by Hiranuma Co., Ltd. and the total amount (Y) (meq/kg) of terminal groups (terminal groups derived from secondary amines) was measured at room temperature (18 to 28° C.).

Then, using these measured values, the amino group concentration was calculated from the following formula.

$$Proportion ( concentration ) of amino groups ( terminal amino groups ) = ( X ) - ( Y ) ( meq / kg )$$

### <Fiber Diameter/Size>

The fibers were embedded using an embedding agent (paraffin resin or epoxy resin), and an image of the cross section of the fiber in the direction perpendicular to the fiber axis was photographed using a SEM at a magnification that allows the filament to be observed.

The area of fibers randomly extracted within the same image was measured from each photographed image, and the diameter found by conversion into a perfect circle was measured in μm to the first decimal place. This was performed for 10 filaments, a simple numerical average of the results was found, and the value rounded to the first decimal place was set to be the fiber diameter (μm).

In this case, when a hollow portion or a gap portion was present in the cross section of the fiber in the direction perpendicular to the fiber axis, the area of the hollow part was also added to the area of the fiber.

Furthermore, the length and size (dimensions) were also measured using a SEM in the same manner.

### <Spinnability>

A 22 dtex, 3 filament thread (fiber) was continuously spun for 96 hours by dry spinning, the number of thread breaks was counted, and the following determinations were made.
Number of thread breaks 0 times=highly favorable ⊚
Number of thread breaks 1 to 2 times=favorable ∘
Number of thread breaks 3 to 4 times=possible Δ
Number of thread breaks 5 times or more=defective x

### <Rupture Elongation, Rupture Strength>

The rupture elongation and rupture strength were measured by subjecting a sample to a tensile test using an Instron model 5564 tensile tester.

A sample having a test length of 5 cm (L1) was subjected to 300% elongation 5 times at a tensile speed of 50 cm/minute. At this time, the stress at 300% elongation was set to be (G1). Next, the length of the sample was maintained for 30 seconds at 300% elongation. The stress after being maintained for 30 seconds was set to be (G2). Next, the length of the sample when elongation of the sample was restored and the stress became 0 was set to be (L2). This operation of 300% elongation, holding, and restoring was repeated, and in a 6th elongation, the sample was elongated until breaking. The stress at the time of rupture was set to be (G3), and the sample length at the time of rupture was set to be (L3). Hereinafter, the above characteristics are calculated using the following formula.
Rupture strength (cN)=(G3)
   20 or more: ⊚, 17 or more and less than 20: ∘, 14 or more and less than 17: Δ, less than 14: x

$$Rupture elongation ( \% ) = 100 \times ( ( L 3 ) - ( L 1 ) ) / ( L 1 )$$

480 or more: ⊚, 460 or more and less than 480: ∘, 430 or more and less than 460: Δ, less than 430: x

### <Heat Resistance>

A two-way half tricot comprised of 85% by mass of nylon filament (24 dtex, 7 filaments) and 15% by mass of the sample (fiber, 44 dtex), which has an on-machine well number of 9/inch and an on-machine course number of 18/inch, was produced by a conventional knitting method to obtain a raw knitted fabric.

The obtained raw knitted fabric was preset under conditions of 3% elongation for 60 seconds at 170° C., and 0.1 mL of Agent 1 was applied, followed by an application of 0.1 mL of Agent 2 (at about the same time or within 1 minute), after which the fabric was subjected to dry heat treatment (after dry heat treatment for 60 seconds at 175° C., the fabric was temporarily taken out and after radiating the heat to room temperature, dry heat treatment was performed for 60 seconds at 180° C.), and next, the fabric was subjected to a bending tester with a maximum elongation of 20% alternately in both the vertical and horizontal directions, twice/second. Note that a mineral oil-based spinning oil for nylon containing 1% oleic acid was used as Agent 1. Furthermore, an aqueous solution of copper acetate (copper concentration of 100 ppm) was used as Agent 2. The raw knitted fabric to which Agent 1 and Agent 2 are adhered in this manner was a model reproduction of a small amount of a mechanical oil (contaminated by a metal component) and a spinning oil for nylon adhered to a nylon-based stretch raw knitted fabric during knitting at a stage before dyeing, and the adhered amount of Agent 1 relative to 0.9 g of the raw knitted fabric was 3.0 mg and the amount of Agent 2 relative to the raw knitted fabric was 3.0 mg.

The obtained stretch fabric was dyed using a conventional method.

The degree of damage to the sample (polyurethane) tissue in the obtained dyed stretch fabric was observed visually with the naked eye or under magnification, and a determination was made using the following criteria. Note that the determination was performed by five people and that the mode (the determination that appeared most frequently) was used. Furthermore, when the determination was divided into two people, two people, and one person, the determination was set to be “Δ.”
⊚: There is no damage, and the knitting structure is uniform.
∘: There is no damage.
Δ: Sagging and depressions are observed in the fabric, and when observed under magnification, the sample (polyurethane elastic fiber) is embrittled.
x: There are holes in the fabric.

### <Combined Durability, Yellowing Resistance>

For combined durability, retention rate of the rupture strength after the sample thread was elongated to 100% and subjected to the following exposure treatments (A), (B), and (C) was found.

For the form of the measurement sample and measurement method of yellowing resistance (yellow discoloration), the sample thread was wound onto a 5×5 cm sample plate with minimal load and in close contact to an extent that the color of the sample plate did not affect the sample, and was designated to be the sample. The front surface of the sample and a working standard white surface (4.3.4 of JIS Z 8722) were tightly covered with a homogeneous, flat, and transparent glass plate of approximately 1 mm. The b value was measured according to JIS L 1013 Method C (Hunter's method) using a Hunter color-difference meter and calculated based on the following formula. The number of measurements was set to be 5, and the average value thereof was adopted.

$$b = 7.0 ( Y - 0.847 Z ) / {Y}^{1 / 2}$$

(However, X, Y, and Z were calculated according to JIS Z 8701)

Yellowing resistance (yellow discoloration) was evaluated using the degree of yellowing (hereinafter abbreviated as Δb) after exposure treatments (A) and (B) of the sample. During each exposure treatment, the degree of yellowing was calculated as follows.

$$Δ b = b value after exposure treatment - b value before exposure treatment$$

Each exposure treatment was performed as follows.

### (A) Ultraviolet (UV) Exposure Treatment

The sample was subjected to exposure treatment for 25 hours at a temperature of 63° C. and a humidity of 60% RH using a carbon arc weather meter manufactured by Suga Test Instruments Co., Ltd.

### (B) Nitrogen Oxide (NOx) Exposure Treatment

The sample was subjected to exposure treatment with 10 ppm of NO₂ gas for 20 hours at a temperature of 40° C. and a humidity of 60% using a sealed container (Scott tester) that has a rotating sample stand.

### (C) Chlorine Bleach (Cl₂) Exposure Treatment

A cycle wherein the sample was exposed to a 500 ppm aqueous solution of “Kao Heiter” manufactured by Kao Corporation in a thermostatic bath at 40° C. for 30 minutes and washed with water for 10 minutes was repeated eight times.

The determination criteria are as follows.

### Combined Durability

60% or more: ⊚, 40% or more and less than 60%: ∘, 20% or more and less than 40%: Δ, less than 20%: x

### Degree of Yellowing

3 or less: ⊚, 3 or more and less than 6: ∘, 6 or more and less than 10: Δ, 10 or more: x

### Reference Example 1

An N,N′-dimethylacetamide (hereinafter sometimes abbreviated as DMAc) solution (35% by mass) that contains tetramethylene ether glycol (PTMG) having a molecular weight of 2,000, 4,4′-diphenylmethane diisocyanate (4,4′-MDI), 2,4′-diphenylmethane diisocyanate (2,4′-MDI), and ethylene diamine (EDA) was polymerized and set to be a polymer solution PUUV.

Note that the molar ratio of 4,4′-MDI to 2,4′-MDI was set to be 97:3, diethylamine was used as a polymerization terminator, and the molar ratio of ethylenediamine to diethylamine was set to be 8:1.

Next, a one-to-one (mass ratio) mixture of a polyurethane (“Methachlor” (registered trademark) 2462 manufactured by DuPont) produced by being reacted with t-butyl diethanolamine and methylene-bis-(4-cyclohexyl isocyanate) and a condensation polymer of p-cresol and divinylbenzene (“Methachlor” (registered trademark) 2390 manufactured by DuPont) was used as an antioxidant, and a DMAc solution (35% by mass) of this mixture was prepared and set to be an antioxidant solution.

The above solution PUUV, antioxidant solution, and ethylenediamine were uniformly mixed in proportions of 99.5 parts by mass, 0.5 parts by mass, and 0.1 parts by mass, respectively, to form a spinning stock solution (spinning solution, dope) having a concentration of 35% by mass.

Note that the initial viscosity of the spinning stock solution was 1,900 P (poise) (=190,000 mPa·s), the viscosity after 24 hours was 1,850 P, and the viscosity ratio of these was calculated as 0.97.

Using the spinning stock solution obtained in this manner as a dope as is, dry spinning was carried out at a dry nitrogen temperature of 300° C. or higher so that DMAc and floating ethylene diamine in the spinning solution were 1/100 or lower of the content of the spinning stock solution.

At this time, a 22 dtex/3 fil multifilament fiber (polyurethane elastic fiber) was spun by setting the speed ratio of the godet roller and the winder to be 1:1.20, the treatment agent (oil) described below was supplied by an oiling roller before winding, the fiber was wound onto a cylindrical paper tube having a length of 58 mm and a winding speed of 600 m/minute using a surface drive winder via a traverse guide that provides a winding width of 38 mm, and a dry spun fiber (polyurethane elastic fiber) was obtained as a 500 g thread roll.

The obtained fiber was a fused thread made by fusing three filaments together. The rotation speed of the oiling roller was adjusted such that the applied dose of treatment agent was a predetermined amount relative to the thread. Furthermore, the applied dose of treatment agent added was measured using n-hexane as an extraction solvent in accordance with JIS-L1073 (synthetic fiber filament thread testing method).

The composition of the treatment agent used in this case is a mixture of 80 parts by mass of polydimethylsiloxane having a viscosity of 1×10⁻⁵ m²/s at 25° C., 15 parts by mass of mineral oil having a viscosity of 1.2×10⁻⁵ m²/s at 25° C., and 5 parts by mass of magnesium distearate having an average particle diameter of 0.5 μm.

Note that the number average molecular weight of the polymer that constitutes the fiber (or thread) was 20,000.

The results including various evaluations and the like are shown in the table.

### Reference Example 2

In Reference Example 1, the prepared solution PUUV was used as is as a spinning stock solution (a spinning stock solution having a concentration of 35% by mass).

Note that the initial viscosity of the spinning stock solution was 2,200 P, the viscosity after 24 hours was 2,000 P, and the viscosity ratio of these was calculated as 0.91.

Then, dry spun fibers were obtained in the same manner as in Reference Example 1 using this spinning stock solution as is as a dope.

Note that the number average molecular weight of the polymer that constitutes the fiber (or thread) was 27,000.

The results including various evaluations and the like are shown in the table.

As is also clear from the table, using the above dope (spinning stock solution) resulted in poorer physical properties (rupture strength, rupture elongation, heat resistance, and yellowing resistance) compared to the case wherein the dope (spinning stock solution) obtained in Reference Example 1 was used.

### Reference Example 3

A spinning stock solution (spinning stock solution having a concentration of 35% by mass) was obtained in the same manner as Reference Example 2, except that in Reference Example 2, the molar ratio of 4,4′-MDI and 2,4′-MDI was set to be 98:1 and that the molar ratio of ethylenediamine and diethylamine was set to be 12:1.

Note that the initial viscosity of the spinning stock solution was 3,000 P, the viscosity after 24 hours was 2,450 P, and the viscosity ratio of these was calculated as 0.82.

Then, dry spun fibers were obtained in the same manner as in Reference Example 1 using this spinning stock solution as is as a dope.

Note that the number average molecular weight of the polymer that constitutes the fiber (or thread) was 30,000.

The results including various evaluations and the like are shown in the table.

As is also clear from the table, using the above dope (spinning stock solution) resulted in poorer physical properties (rupture strength, heat resistance, and yellowing resistance) compared to the case wherein the dope (spinning stock solution) obtained in Reference Example 1 was used.

### Reference Example 4

A fibrous polyurethane [polyurethane composition (PTMG, MDI, BDO (butanediol)), a crushed product of a post consumer thread manufactured by a melt spinning method (length of approximately 2 mm, fiber diameter (average fiber diameter) of 244 μm)] was prepared.

Note that, for crushing, crushing was performed until the size became 2 mm using a three-blade helical cutting type crusher.

The initial viscosity of this polyurethane in a 20% by mass DMAc solution was measured to be 2,200 P, the viscosity after 24 hours was measured to be 1,975 P, and the viscosity ratio of these was calculated as 0.90.

Furthermore, the number average molecular weight of this polyurethane was 23,000, and there was no peak (peak top) in the region of the molecular weight (number average molecular weight) of one million or more (region of the GPC chart corresponding to a molecular weight (number average molecular weight of one million or more).

Next, the above polyurethane, the spinning stock solution obtained in Reference Example 1, and DMAc were mixed and stirred at 23° C. (ambient temperature) for 4 hours to prepare a solution.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass, and the proportion of the above polyurethane in the total solid content (polymer, polyurethane) contained in the dope was set to be 30% by mass.

Furthermore, the initial viscosity of this dope was 2,200 P, the viscosity after 24 hours was 1,700 P, and the viscosity ratio of these was calculated as 0.77.

Then, using this dope, a dry spun fiber was obtained in the same manner as in Reference Example 1.

Note that the number average molecular weight of the polymer that constitutes the fiber (or thread) was 20,000.

The results including various evaluations and the like are shown in the table.

As is also clear from the table, using the dope (spinning stock solution) combined with the above polyurethane was used resulted in poorer physical properties (yellowing resistance) in the obtained fiber compared to the case wherein the dope (spinning stock solution) obtained in Reference Example 1 was used.

### Example 1

A fibrous polyurethane [polyurethane composition (PTMG, MDI, BDO), a crushed product of a post consumer thread manufactured by a dry spinning method (length of approximately 2 mm, fiber diameter (average fiber diameter) of 260 μm)] was prepared.

Note that, for crushing, crushing was performed until the size became 2 mm using a three-blade helical cutting type crusher.

The initial viscosity of this polyurethane in a 20% by mass DMAc solution was measured to be 1,800 P, the viscosity after 24 hours was measured to be 2,000 P, and the viscosity ratio of these was calculated as 1.11.

Furthermore, the number average molecular weight of this polyurethane was 30,000, and there was a peak (present) in the region of the molecular weight (number average molecular weight) of one million or more.

Then, using this polyurethane, a dope was obtained in the same manner as in Reference Example 4.

The concentration of this dope was 35% by mass, and the proportion of the above polyurethane in the total solid content (polymer, polyurethane) contained in the dope was set to be 30% by mass.

Furthermore, the initial viscosity of this dope was 2,600 P, the viscosity after 24 hours was 2,600 P, and the viscosity ratio of these was calculated as 1.00.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

As is also clear from the table, using the dope (spinning stock solution) combined with the above polyurethane significantly improved spinnability and resulted in significantly superior physical properties (rupture elongation, heat resistance, combined durability) in the obtained fibers as well compared to the case wherein the dope (spinning stock solution) obtained in Reference Example 1 was used.

As described above, the dope (spinning stock solution) obtained in Reference Example 1 is a dope that can realize superior physical properties compared to the dopes of Reference Examples 2 and 3, which were manufactured separately from Reference Example 1, but even when compared to the dope obtained in Reference Example 1, such remarkable improvements in spinnability and further remarkable improvements in physical properties could be realized.

### Example 2

A dope (dope having a concentration of 35% by mass) was obtained in the same manner as in Example 1, except that in Example 1, the proportion of the above polyurethane in the total solid content (polymer, polyurethane) contained in the dope was 60% by mass.

The initial viscosity of this dope was 1,950 P, the viscosity after 24 hours was 2,600 P, and the viscosity ratio of these was calculated as 1.33.

Then, using this dope, a dry spun fiber was obtained in the same manner as in Reference Example 1.

Note that the number average molecular weight of the polymer that constitutes the fiber (or thread) was 29,500.

The results including various evaluations and the like are shown in the table.

As is also clear from the table, using the dope (spinning stock solution) combined with the above polyurethane significantly improved spinnability and resulted in significantly superior physical properties (rupture strength, rupture elongation, heat resistance, combined durability) in the obtained fibers as well compared to the case wherein the dope (spinning stock solution) obtained in Reference Example 1 was used.

Note that the physical properties (rupture strength) were significantly superior to Example 1 in which the addition proportion was lower.

### Example 3

A dope was obtained in the same manner as in Example 1, except that, in Example 1, a DMAc dispersion (35% by mass) of a metal soap (magnesium stearate) and a DMAc dispersion (35% by mass) of a surfactant (polyoxyethylene lauryl ether) were uniformly mixed (combined) in the dope (35% by mass) such that each was 1 part by mass with respect to 98 parts by mass of the dope.

The initial viscosity of this dope was 1,900 P, the viscosity after 24 hours was 2,700 P, and the viscosity ratio of these was calculated as 1.42.

Then, using this dope, a dry spun fiber was obtained in the same manner as in Reference Example 1.

Note that the number average molecular weight of the polymer that constitutes the fiber (or thread) was 30,000.

The results including various evaluations and the like are shown in the table.

As is also clear from the table, using the dope (spinning stock solution) combined with the above polyurethane significantly improved spinnability and resulted in significantly superior physical properties (rupture strength, rupture elongation, heat resistance, combined durability) in the obtained fibers as well compared to the case wherein the dope (spinning stock solution) obtained in Reference Example 1 was used.

Note that the spinnability and physical properties (rupture strength, rupture elongation) were significantly superior compared to those of Example 1, wherein a metal soap and a surfactant were not combined thereto.

Thus, similar results can be obtained even when a polyurethane containing a metal soap (and additionally a surfactant) is used.

In order to confirm this, the same amount of metal soap (and surfactant) was included in the polyurethane in advance, and dry spun fibers were obtained in the same manner as above, but the results showed similar tendencies in spinnability and physical properties.

Note that for the polyurethane in which a metal soap (and surfactant) was included in advance, the initial viscosity in a 20% by mass DMAc solution was measured to be 1,760 P, the viscosity after 24 hours was measured to be 1,970 P, and the viscosity ratio of these was calculated as 1.12.

### Example 4

A dope was obtained in the same manner as in Example 1, except that in Example 1, a DMAc solution (35% by mass) of an antioxidant (ethylene-1,2-bis(3,3-bis[3-t-butyl-4-hydroxyphenyl] butyrate)) was uniformly mixed (combined) into the dope (35% by mass) such that the DMAc solution is 3 parts by mass with respect to 97 parts by mass of the dope.

The initial viscosity of this dope was 1,800 P, the viscosity after 24 hours was 2,600 P, and the viscosity ratio of these was calculated as 1.44.

Then, using this dope, a dry spun fiber was obtained in the same manner as in Reference Example 1.

Note that the number average molecular weight of the polymer that constitutes the fiber (or thread) was 31,000.

The results including various evaluations and the like are shown in the table.

As is also clear from the table, using the dope (spinning stock solution) combined with the above polyurethane significantly improved spinnability and resulted in significantly superior physical properties (rupture strength, rupture elongation, heat resistance, combined durability) in the obtained fibers as well compared to the case wherein the dope (spinning stock solution) obtained in Reference Example 1 was used.

Note that the spinnability and physical properties (rupture strength, heat resistance, combined durability) were significantly superior compared to those of Example 1, in which an antioxidant was not combined thereto.

Thus, similar results can be obtained even when a polyurethane containing an antioxidant is used.

In order to confirm this, the same amount of antioxidant was included in the polyurethane in advance, and dry spun fibers were obtained in the same manner as above, but the results indicated similar tendencies in spinnability and physical properties.

Note that for the polyurethane in which an antioxidant was included in advance, the initial viscosity in a 20% by mass DMAc solution was measured to be 1,710 P, the viscosity after 24 hours was measured to be 1,900 P, and the viscosity ratio of these was calculated as 1.11.

### Example 5

A fibrous polyurethane [polyurethane composition (PTMG, MDI, EDA), a crushed product of a post consumer thread manufactured by a dry spinning method (length of approximately 2 mm, fiber diameter (average fiber diameter) of 220 μm)] was prepared.

Note that, for crushing, crushing was performed until the size became 2 mm using a three-blade helical cutting type crusher.

The initial viscosity of this polyurethane in a 20% by mass DMAc solution was measured to be 2,900 P, the viscosity after 24 hours was measured to be 3,050 P, and the viscosity ratio of these was calculated as 1.05.

Furthermore, the number average molecular weight of this polyurethane was 30,000, and there was a peak in the region of the number average molecular weight of one million or more.

Then, using this polyurethane, a dope was obtained in the same manner as in Reference Example 4.

The concentration of this dope was 35% by mass, and the proportion of the above polyurethane in the total solid content (polymer, polyurethane) contained in the dope was set to be 30% by mass.

Furthermore, the initial viscosity of this dope was 2,600 P, the viscosity after 24 hours was 2,800 P, and the viscosity ratio of these was calculated as 1.08.

Then, using this dope, a dry spun fiber was obtained in the same manner as in Reference Example 1.

Note that the number average molecular weight of the polymer that constitutes the fiber (or thread) was 30,000.

The results including various evaluations and the like are shown in the table.

As is also clear from the table, using the dope (spinning stock solution) combined with the above polyurethane significantly improved spinnability and resulted in significantly superior physical properties (rupture strength, rupture elongation, heat resistance, combined durability) in the obtained fibers as well compared to the case wherein the dope (spinning stock solution) obtained in Reference Example 1 was used.

The polyurethane was different from that used in Example 1, but it was understood that similar tendencies were exhibited.

### Example 6

A fibrous polyurethane [polyurethane composition (PTMG, MDI, EDA), a crushed product of a thread roll manufactured by a dry spinning method (length of approximately 2 mm, fiber diameter (average fiber diameter) of 225 μm)] was prepared.

Note that, for crushing, crushing was performed until the size became 2 mm using a three-blade helical cutting type crusher.

The initial viscosity of this polyurethane in a 20% by mass DMAc solution was measured to be 3,000 P, the viscosity after 24 hours was measured to be 3,900 P, and the viscosity ratio of these was calculated as 1.30.

Furthermore, the number average molecular weight of this polyurethane was 30,500, and there was a peak in the region of the molecular weight (number average molecular weight) of one million or more.

Then, using this polyurethane, a dope was obtained in the same manner as in Reference Example 4.

The concentration of this dope was 35% by mass, and the proportion of the above polyurethane in the total solid content (polymer, polyurethane) contained in the dope was set to be 30% by mass.

Furthermore, the initial viscosity of this dope was 2,900 P, the viscosity after 24 hours was 3,200 P, and the viscosity ratio of these was calculated as 1.10.

Then, using this dope, a dry spun fiber was obtained in the same manner as in Reference Example 1.

Note that the number average molecular weight of the polymer that constitutes the fiber (or thread) was 33,000.

The results including various evaluations and the like are shown in the table.

As is also clear from the table, using the dope (spinning stock solution) combined with the above polyurethane significantly improved spinnability and resulted in significantly superior physical properties (rupture strength, rupture elongation, heat resistance, combined durability) in the obtained fibers as well compared to the case wherein the dope (spinning stock solution) obtained in Reference Example 1 was used.

The polyurethane was different from that used in Example 1, but it was understood that similar tendencies were exhibited.

In particular, the improvement in spinnability was exceptionally remarkable, perhaps due to the viscosity ratio after 24 hours in a 20% by mass DMAc solution being higher than that of the polyurethane used in Example 1.

### Example 7

Fibrous polyurethane [polyurethane composition (PTMG, MDI, EDA), a crushed product of a thread roll manufactured by a dry spinning method (length of approximately 2 mm, fiber diameter (average fiber diameter) of 560 μm)] was prepared.

Note that, for crushing, crushing was performed until the size became 2 mm using a three-blade helical cutting type crusher.

The initial viscosity of this polyurethane in a 20% by mass DMAc solution was measured to be 4,200 P, the viscosity after 24 hours was measured to be 6,500 P, and the viscosity ratio of these was calculated as 1.55.

Furthermore, the number average molecular weight of this polyurethane was 30,000, and there was a peak in the region of the molecular weight (number average molecular weight) of one million or more.

Next, the 20% by mass DMAc solution of the above polyurethane was concentrated under reduced pressure at 60° C. until the solution became a 35% by mass DMAc solution, mixed with the spinning stock solution obtained in Reference Example 1, and stirred for 2 hours to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,900 P, the viscosity after 24 hours was 4,200 P, and the viscosity ratio of these was calculated as 1.45.

Then, using this dope, a dry spun fiber was obtained in the same manner as in Reference Example 1.

Note that the number average molecular weight of the polymer that constitutes the fiber (or thread) was 30,000.

The results including various evaluations and the like are shown in the table.

As is also clear from the table, using the dope (spinning stock solution) combined with the above polyurethane significantly improved spinnability and resulted in significantly superior physical properties (rupture strength, rupture elongation, heat resistance, combined durability, yellowing resistance) in the obtained fibers as well compared to the case wherein the dope (spinning stock solution) obtained in Reference Example 1 was used.

The polyurethane was different from that used in Example 1, and the preparation method of the dope was also changed, but it was understood that similar tendencies were exhibited.

### Example 8

Fibrous polyurethane [polyurethane composition (PTMG, MDI, EDA), a crushed product of a thread roll manufactured by a dry spinning method (length of approximately 2 mm, fiber diameter (average fiber diameter) of 1,265 μm)] was prepared.

Note that, for crushing, crushing was performed until the size became 2 mm using a three-blade helical cutting type crusher.

The initial viscosity of this polyurethane in a 20% by mass DMAc solution was measured to be 2,900 P, the viscosity after 24 hours was measured to be 8,600 P, and the viscosity ratio of these was calculated as 2.97.

Furthermore, the number average molecular weight of this polyurethane was 29,000, and there was a peak in the region of the molecular weight (number average molecular weight) of one million or more.

Next, the 20% by mass DMAc solution of the above polyurethane was concentrated under reduced pressure at 80° C. until the solution became a 35% by mass DMAc solution, and mixed with the spinning stock solution obtained in Reference Example 1 to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,680 P, the viscosity after 24 hours was 3,800 P, and the viscosity ratio of these was calculated as 1.42.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

As is also clear from the table, using the dope (spinning stock solution) combined with the above polyurethane significantly improved spinnability and resulted in significantly superior physical properties (rupture strength, rupture elongation, heat resistance, combined durability, yellowing resistance) in the obtained fibers as well compared to the case wherein the dope (spinning stock solution) obtained in Reference Example 1 was used.

The polyurethane was different from that used in Example 1, and the preparation method of the dope was also changed, but it was understood that similar tendencies were exhibited.

### Example 9

Fibrous polyurethane [polyurethane composition (PTMG, MDI, EDA), a crushed product of a thread roll manufactured by a dry spinning method (length of approximately 2 mm, fiber diameter (average fiber diameter) of 1,205 μm)] was prepared.

Note that, for crushing, crushing was performed until the size became 2 mm using a three-blade helical cutting type crusher.

The initial viscosity of this polyurethane in a 20% by mass DMAc solution was measured to be 4,200 P, the viscosity after 24 hours was measured to be 10,500 P, and the viscosity ratio of these was calculated as 2.50.

Furthermore, the number average molecular weight of this polyurethane was 28,000, and there was a peak in the region of the molecular weight (number average molecular weight) of one million or more.

Next, the above polyurethane, the spinning stock solution obtained in Reference Example 1, and diethylamine were mixed and stirred for 2 hours to prepare a solution (dope).

Note that a cylindrical container was used for stirring, and a helical ribbon stirring blade covering 85% of the projected outer surface of the bottom of the container was used.

The concentration of this dope was 35% by mass, the proportion of the above polyurethane in the total solid content (polymer, polyurethane) contained in the dope was 30% by mass, and the proportion of diethylamine was set to be 0.2% by mass.

Furthermore, the initial viscosity of this dope was 3,300 P, the viscosity after 24 hours was 4,300 P, and the viscosity ratio of these was calculated as 1.30.

Then, using this dope, a dry spun fiber was obtained in the same manner as in Reference Example 1.

Note that the number average molecular weight of the polymer that constitutes the fiber (or thread) was 44,000.

The results including various evaluations and the like are shown in the table.

As is also clear from the table, using the dope (spinning stock solution) combined with the above polyurethane significantly improved spinnability and resulted in significantly superior physical properties (rupture strength, rupture elongation, heat resistance, combined durability) in the obtained fibers as well compared to the case wherein the dope (spinning stock solution) obtained in Reference Example 1 was used.

The polyurethane was different from that used in Example 1, and the preparation method of the dope was also changed, but it was understood that similar tendencies were exhibited.

### Example 10

Fibrous polyurethane [polyurethane composition (PTMG, MDI, EDA), a crushed product of a thread roll manufactured by a dry spinning method (length of approximately 2 mm, fiber diameter (average fiber diameter) of 1,245 μm)] was prepared.

Note that, for crushing, crushing was performed until the size became 2 mm using a three-blade helical cutting type crusher.

The initial viscosity of this polyurethane in a 20% by mass DMAc solution was measured to be 4,200 P, the viscosity after 24 hours was measured to be 6,600 P, and the viscosity ratio of these was calculated as 1.57.

Furthermore, the number average molecular weight of this polyurethane was 30,000, and there was a peak in the region of the molecular weight (number average molecular weight) of one million or more.

Next, 2 parts by mass of a 20% by mass DMAc solution of a surfactant (polyoxyethylene styrenated phenyl ether) was combined with 98 parts by mass of a 20% by mass DMAc solution of the above polyurethane to prepare a solution. Then, this was mixed with the spinning stock solution obtained in Reference Example 1.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass, the proportion of the above polyurethane in the total solid content (polymer, polyurethane) contained in the dope was set to be 30% by mass, and the proportion of the surfactant was set to be 0.6% by mass.

Furthermore, the initial viscosity of this dope was 3,300 P, the viscosity after 24 hours was 4,300 P, and the viscosity ratio of these was calculated as 1.30.

Then, using this dope, a dry spun fiber was obtained in the same manner as in Reference Example 1.

Note that the number average molecular weight of the polymer that constitutes the fiber (or thread) was 40,000.

The results including various evaluations and the like are shown in the table.

As is also clear from the table, using the dope (spinning stock solution) combined with the above polyurethane significantly improved spinnability and resulted in significantly superior physical properties (rupture strength, rupture elongation, heat resistance, combined durability) in the obtained fibers as well compared to the case wherein the dope (spinning stock solution) obtained in Reference Example 1 was used.

The polyurethane was different from that used in Example 1, and the preparation method of the dope was also changed, but it was understood that similar tendencies were exhibited.

### Example 11

Fibrous polyurethane [polyurethane composition (PTMG, MDI, EDA), a crushed product of a thread roll manufactured by a dry spinning method (length of approximately 2 mm, fiber diameter (average fiber diameter) of 1,222 μm)] was prepared.

Note that, for crushing, crushing was performed until the size became 2 mm using a three-blade helical cutting type crusher.

The initial viscosity of this polyurethane in a 20% by mass DMAc solution was measured to be 2,800 P, the viscosity after 24 hours was measured to be 9,000 P, and the viscosity ratio of these was calculated as 3.21.

Furthermore, the number average molecular weight of this polyurethane was 33,000, and there was a peak in the region of the molecular weight (number average molecular weight) of one million or more.

Next, the above polyurethane, the spinning stock solution obtained in Reference Example 1, and a 20% by mass DMAc solution of a hindered phenol antioxidant [ethylene-1,2-bis(3,3-bis[3-t-butyl-4-hydroxyphenyl] butyrate)] were mixed to prepare a solution.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass, the proportion of the above polyurethane in the total solid content (polymer, polyurethane) contained in the dope was set to be 30% by mass, and the proportion of hindered phenol antioxidant was set to be 1.0% by mass.

Furthermore, the initial viscosity of this dope was 4,200 P, the viscosity after 24 hours was 8,080 P, and the viscosity ratio of these was calculated as 1.92.

Then, using this dope, a dry spun fiber was obtained in the same manner as in Reference Example 1.

Note that the number average molecular weight of the polymer that constitutes the fiber (or thread) was 34,000.

The results including various evaluations and the like are shown in the table.

As is also clear from the table, using the dope (spinning stock solution) combined with the above polyurethane significantly improved spinnability and resulted in significantly superior physical properties (rupture strength, rupture elongation, heat resistance, combined durability) in the obtained fibers as well compared to the case wherein the dope (spinning stock solution) obtained in Reference Example 1 was used.

The polyurethane was different from that used in Example 1, and the preparation method of the dope was also changed, but it was understood that similar tendencies were exhibited.

### Example 12

Fibrous polyurethane [polyurethane composition (PTMG, MDI, EDA), a crushed product of a thread roll manufactured by a dry spinning method (length of approximately 2 mm, fiber diameter (average fiber diameter) of 660 μm)] was prepared.

Note that, for crushing, crushing was performed until the size became 2 mm using a three-blade helical cutting type crusher.

The initial viscosity of this polyurethane in a 20% by mass DMAc solution was measured to be 2,800 P, the viscosity after 24 hours was measured to be 9,000 P, and the viscosity ratio of these was calculated as 3.21.

Furthermore, the number average molecular weight of this polyurethane was 33,000, and there was a peak in the region of the molecular weight (number average molecular weight) of one million or more.

Next, the above polyurethane, a hindered phenol antioxidant [ethylene-1,2-bis(3,3-bis[3-t-butyl-4-hydroxyphenyl]butyrate)], and a 20% by mass DMAc solution of ethylenediamine were mixed to prepare a solution (dope).

Note that a cylindrical container was used for stirring, and a helical ribbon stirring blade covering 85% of the projected outer surface of the bottom of the container was used.

The concentration of this dope was 35% by mass (of which the concentration of the hindered phenolic antioxidant was 0.7% by mass and the concentration of ethylenediamine was 0.07% by mass).

Furthermore, the initial viscosity of this dope was 7,200 P, the viscosity after 24 hours was 12,100 P, and the viscosity ratio of these was calculated as 1.68.

Then, using this dope, a dry spun fiber was obtained in the same manner as in Reference Example 1.

Note that the number average molecular weight of the polymer that constitutes the fiber (or thread) was 53,000.

The results including various evaluations and the like are shown in the table.

As is also clear from the table, using the dope (spinning stock solution) combined with the above polyurethane significantly improved spinnability and resulted in significantly superior physical properties (rupture strength, combined durability) in the obtained fibers as well compared to the case wherein the dope (spinning stock solution) obtained in Reference Example 1 was used.

The polyurethane was different from that used in Example 1 and the proportion of the polyurethane in the dope was also changed from Example 12 (the polyurethane in the dope was set to the above only), but it was understood that the same tendencies were exhibited.

Note that comparison with other examples suggested that it is more advantageous in terms of physical properties when the dope is formed by combining the above polyurethane and a separate polyurethane polymerization component.

### Example 13

A polyurethane urea resin molded product (RIM molded product) [a crushed product comprised of polyurethane urea (PTMG, MDI, EDA) (granular, particle size of approximately 0.1 to 2 mm)] was prepared.

Note that, for crushing, crushing was performed using a three-blade helical cutting type crusher.

The initial viscosity of this polyurethane in a 20% by mass DMAc solution was measured to be 2,900 P, the viscosity after 24 hours was measured to be 3,200 P, and the viscosity ratio of these was calculated as 1.10.

Next, the above polyurethane, the spinning stock solution obtained in Reference Example 1, diethylamine, and DMAc were mixed and stirred at 40° C. (ambient temperature) for 2 hours to prepare a solution.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass, the proportion of the above polyurethane in the total solid content (polymer, polyurethane) contained in the dope was 30% by mass, and the proportion of diethylamine was set to be 0.06% by mass.

Furthermore, the initial viscosity of this dope was 3,000 P, the viscosity after 24 hours was 2,800 P, and the viscosity ratio of these was calculated as 0.93.

Then, using this dope, a dry spun fiber was obtained in the same manner as in Reference Example 1.

Note that the number average molecular weight of the polymer that constitutes the fiber (or thread) was 12,000.

The results including various evaluations and the like are shown in the table.

As is also clear from the table, using the dope (spinning stock solution) combined with the above polyurethane significantly improved spinnability and resulted in significantly superior physical properties (heat resistance) in the obtained fibers as well compared to the case wherein the dope (spinning stock solution) obtained in Reference Example 1 was used.

The polyurethane was different from that used in Example 1, but it was understood that similar tendencies were exhibited. Note that comparison with other examples suggested that a polyurethane form that is fibrous is more advantageous in terms of spinnability and physical properties.

### Example 14

Fibrous polyurethane [polyurethane composition (PTMG, MDI, EDA), a thread roll of a post consumer thread manufactured by a wet spinning method (length of approximately 2 mm, fiber diameter (average fiber diameter) of 660 μm)] was prepared.

Note that, for crushing, crushing was performed until the size became 2 mm using a three-blade helical cutting type crusher.

The initial viscosity of this polyurethane in a 20% by mass DMAc solution was measured to be 2,800 P, the viscosity after 24 hours was measured to be 12,000 P, and the viscosity ratio of these was calculated as 4.29.

Furthermore, the number average molecular weight of this polyurethane was 33,000, and there was no peak in the region of the molecular weight (number average molecular weight) of one million or more.

Next, the above polyurethane and DMAc were mixed and stirred at 23° C. (ambient temperature) for 2 hours to prepare a solution.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass.

Furthermore, the initial viscosity of this dope was 6,600 P, the viscosity after 24 hours was 13,400 P, and the viscosity ratio of these was calculated as 2.03.

Then, using this dope, a dry spun fiber was obtained in the same manner as in Reference Example 1.

Note that the number average molecular weight of the polymer that constitutes the fiber (or thread) was 34,000.

The results including various evaluations and the like are shown in the table.

As is also clear from the table, using the above dope (spinning stock solution) combined with the above polyurethane resulted in physical properties that are comparable or some physical properties (combined durability) that are significantly superior in the obtained fibers as well compared to the case wherein the dope (spinning stock solution) obtained in Reference Example 1 was used.

Note that comparison with other examples suggested that it is more advantageous in terms of spinnability and physical properties when the viscosity ratio after 24 hours in a 20% by mass DMAc solution is not too large or when high molecular weight components are contained.

### Example 15

Fibrous polyurethane [polyurethane composition (PTMG, MDI, EDA), a thread roll of a post consumer thread manufactured by a wet spinning method (length of approximately 2 mm, fiber diameter (average fiber diameter) of 1,290 μm)] was prepared.

Note that, for crushing, crushing was performed until the size became 2 mm using a three-blade helical cutting type crusher.

The initial viscosity of this polyurethane in a 20% by mass DMAc solution was measured to be 2,200 P, the viscosity after 24 hours was measured to be 8,850 P, and the viscosity ratio of these was calculated as 4.02.

Furthermore, the number average molecular weight of this polyurethane was 33,000, and there was a peak in the region of the molecular weight (number average molecular weight) of one million or more.

Next, the above polyurethane and DMAc were mixed and stirred at 23° C. (ambient temperature) for 2 hours to prepare a solution.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass.

Furthermore, the initial viscosity of this dope was 3,020 P, the viscosity after 24 hours was 6,450 P, and the viscosity ratio of these was calculated as 2.14.

Then, using this dope, a dry spun fiber was obtained in the same manner as in Reference Example 1.

Note that the number average molecular weight of the polymer that constitutes the fiber (or thread) was 42,000.

The results including various evaluations and the like are shown in the table.

As is also clear from the table, using the above dope (spinning stock solution) combined with the above polyurethane could significantly improve spinnability and resulted in physical properties that are comparable or some physical properties (combined durability) that are significantly superior in the obtained fibers as well compared to the case wherein the dope (spinning stock solution) obtained in Reference Example 1 was used.

Note that comparison with other examples suggested that it is more advantageous in terms of spinnability and physical properties when the viscosity ratio after 24 hours in a 20% by mass DMAc solution was not too large.

TABLE 1

| | | | | | | Dope | | |
|---|---|---|---|---|---|---|---|---|
| | | | | | | Polyurethane | | |
| | Polyurethane (A) | | | | | (A)/resin | | |
| | V1 | V2 | | | Peak of Mn 1 | (solid content) | V1 | V2 |
| | P | P | V2/V1 | Mn | million or more | % by mass | P | P |
| Reference Example 1 | — | — | — | — | — | 0 | 1900 | 1850 |
| Reference Example 2 | — | — | — | — | — | 0 | 2200 | 2000 |
| Reference Example 3 | — | — | — | — | — | 0 | 3000 | 2450 |
| Reference Example 4 | 2200 | 1975 | 0.90 | 23000 | No | 30 | 2200 | 1700 |
| Example 1 | 1800 | 2000 | 1.11 | 30000 | Yes | 30 | 2600 | 2600 |
| Example 2 | 1800 | 2000 | 1.11 | 30000 | Yes | 60 | 1950 | 2600 |
| Example 3 | 1800 | 2000 | 1.11 | 30000 | Yes | 30 | 1900 | 2700 |
| Example 4 | 1800 | 2000 | 1.11 | 30000 | Yes | 30 | 1800 | 2600 |
| Example 5 | 2900 | 3050 | 1.05 | 30000 | Yes | 30 | 2600 | 2800 |
| Example 6 | 3000 | 3900 | 1.30 | 30500 | Yes | 30 | 2900 | 3200 |
| Example 7 | 4200 | 6500 | 1.55 | 30000 | Yes | 30 | 2900 | 4200 |
| Example 8 | 2900 | 8600 | 2.97 | 29000 | Yes | 30 | 2680 | 3800 |
| Example 9 | 4200 | 10500 | 2.50 | 28000 | Yes | 30 | 3300 | 4300 |
| Example 10 | 4200 | 6600 | 1.57 | 30000 | Yes | 30 | 3300 | 4300 |
| Example 11 | 2800 | 9000 | 3.21 | 33000 | Yes | 30 | 4200 | 8080 |
| Example 12 | 2800 | 9000 | 3.21 | 33000 | Yes | 100 | 7200 | 12100 |
| Example 13 | 2900 | 3200 | 1.10 | — | — | 30 | 3000 | 2800 |
| Example 14 | 2800 | 12000 | 4.29 | 33000 | No | 100 | 6600 | 13400 |
| Example 15 | 2200 | 8850 | 4.02 | 33000 | Yes | 100 | 3020 | 6450 |

| | | | Evaluation | | | | | |
|---|---|---|---|---|---|---|---|---|
| | Dope | | | Rupture | Rupture | Heat | Combined | Yellowing |
| | V2/V1 | Mn | Spinnability | strength | elongation | resistance | durability | resistance |
| Reference Example 1 | 0.97 | 20000 | X | Δ | Δ | Δ | Δ | ◯ |
| Reference Example 2 | 0.91 | 27000 | X | X | X | X | Δ | Δ |
| Reference Example 3 | 0.82 | 30000 | X | Δ | Δ | X | Δ | Δ |
| Reference Example 4 | 0.77 | 20000 | X | Δ | Δ | Δ | Δ | Δ |
| Example 1 | 1.00 | 29000 | Δ | Δ | ◯ | ◯ | ◯ | ◯ |
| Example 2 | 1.33 | 29500 | Δ | ◯ | ◯ | ◯ | ◯ | ◯ |
| Example 3 | 1.42 | 30000 | ◯ | ◯ | ⊚ | ◯ | ◯ | ◯ |
| Example 4 | 1.44 | 31000 | ◯ | ◯ | ◯ | ⊚ | ⊚ | ◯ |
| Example 5 | 1.08 | 30000 | ◯ | ◯ | ◯ | ◯ | ◯ | ◯ |
| Example 6 | 1.10 | 33000 | ⊚ | ◯ | ◯ | ◯ | ◯ | ◯ |
| Example 7 | 1.45 | 30000 | ⊚ | ⊚ | ⊚ | ⊚ | ◯ | ⊚ |
| Example 8 | 1.42 | 29000 | ⊚ | ⊚ | ⊚ | ⊚ | ◯ | ⊚ |
| Example 9 | 1.30 | 44000 | ⊚ | ◯ | ◯ | ◯ | ◯ | ◯ |
| Example 10 | 1.30 | 40000 | ⊚ | ◯ | ◯ | ◯ | ◯ | ◯ |
| Example 11 | 1.92 | 34000 | ◯ | ⊚ | ◯ | ◯ | ◯ | ◯ |
| Example 12 | 1.68 | 53000 | ◯ | ◯ | Δ | Δ | ◯ | Δ |
| Example 13 | 0.93 | 12000 | Δ | Δ | Δ | ◯ | ◯ | ◯ |
| Example 14 | 2.03 | 34000 | Δ | Δ | Δ | Δ | ◯ | ◯ |
| Example 15 | 2.14 | 42000 | Δ | Δ | Δ | Δ | ◯ | ◯ |

### Example 16

A fibrous polyurethane [polyurethane composition (PTMG, MDI, EDA), a crushed product of a post consumer thread manufactured by a dry spinning method (length of approximately 2 mm, fiber diameter (average fiber diameter) of 220 μm)] was prepared.

Note that, for crushing, crushing was performed until the size became 2 mm using a three-blade helical cutting type crusher.

The initial viscosity of this polyurethane in a 20% by mass DMAc solution was measured to be 2,900 P, the viscosity after 24 hours was measured to be 3,050 P, and the viscosity ratio of these was calculated as 1.05.

Furthermore, the number average molecular weight of this polyurethane was 30,000, and there was a peak in the region of the number average molecular weight of one million or more. Additionally, the amino group concentration of this polyurethane was 2.2 meq/kg.

Then, using this polyurethane, a dope was obtained in the same manner as in Reference Example 4.

The concentration of this dope was 35% by mass, and the proportion of the above polyurethane in the total solid content (polymer, polyurethane) contained in the dope was set to be 30% by mass.

Furthermore, the initial viscosity of this dope was 2,600 P, the viscosity after 24 hours was 2,800 P, and the viscosity ratio of these was calculated as 1.08.

Then, using this dope, a dry spun fiber was obtained in the same manner as in Reference Example 1.

Note that the number average molecular weight of the polymer that constitutes the fiber (or thread) was 30,000.

The results including various evaluations and the like are shown in the table.

### Example 17

A fibrous polyurethane [polyurethane composition (PTMG, MDI, EDA), a crushed product of a post consumer thread manufactured by a dry spinning method (length of approximately 2 mm, fiber diameter (average fiber diameter) of 220 μm)] was prepared.

Note that, for crushing, crushing was performed until the size became 2 mm using a three-blade helical cutting type crusher.

Furthermore, the obtained crushed product was dissolved (or dispersed) in DMAc, and then filtered to obtain polyurethane.

The initial viscosity of this polyurethane in a 20% by mass DMAc solution was measured to be 2,400 P, the viscosity after 24 hours was measured to be 3,070 P, and the viscosity ratio of these was calculated as 1.54.

Furthermore, the number average molecular weight of this polyurethane was 30,000, and there was no peak in the region of the molecular weight (number average molecular weight) of one million or more. Additionally, the amino group concentration of this polyurethane was 0.9 meq/kg.

Then, using this polyurethane, a dope was obtained in the same manner as in Reference Example 4.

The concentration of this dope was 35% by mass, and the proportion of the above polyurethane in the total solid content (polymer, polyurethane) contained in the dope was set to be 30% by mass.

Furthermore, the initial viscosity of this dope was 2,900 P, the viscosity after 24 hours was 2,950 P, and the viscosity ratio of these was calculated as 1.02.

Then, using this dope, a dry spun fiber was obtained in the same manner as in Reference Example 1.

Note that the number average molecular weight of the polymer that constitutes the fiber (or thread) was 28,000.

The results including various evaluations and the like are shown in the table.

### Example 18

A fibrous polyurethane [polyurethane composition (PTMG, MDI, EDA), a crushed product of a thread roll manufactured by a dry spinning method (length of approximately 2 mm, fiber diameter (average fiber diameter) of 225 μm)] was prepared.

Note that, for crushing, crushing was performed until the size became 2 mm using a three-blade helical cutting type crusher.

The initial viscosity of this polyurethane in a 20% by mass DMAc solution was measured to be 3,000 P, the viscosity after 24 hours was measured to be 3,900 P, and the viscosity ratio of these was calculated as 1.30.

Furthermore, the number average molecular weight of this polyurethane was 30,500, and there was a peak in the region of the molecular weight (number average molecular weight) of one million or more. Additionally, the amino group concentration of this polyurethane was 5.5 meq/kg.

Then, using this polyurethane, a dope was obtained in the same manner as in Reference Example 4.

The concentration of this dope was 35% by mass, and the proportion of the above polyurethane in the total solid content (polymer, polyurethane) contained in the dope was set to be 30% by mass.

Furthermore, the initial viscosity of this dope was 2,900 P, the viscosity after 24 hours was 3,200 P, and the viscosity ratio of these was calculated as 1.10.

Then, using this dope, a dry spun fiber was obtained in the same manner as in Reference Example 1.

Note that the number average molecular weight of the polymer that constitutes the fiber (or thread) was 33,000.

The results including various evaluations and the like are shown in the table.

### Example 19

Fibrous polyurethane [polyurethane composition (PTMG, MDI, EDA), a crushed product of a thread roll manufactured by a dry spinning method (length of approximately 2 mm, fiber diameter (average fiber diameter) of 560 μm)] was prepared.

Note that, for crushing, crushing was performed until the size became 2 mm using a three-blade helical cutting type crusher.

The initial viscosity of this polyurethane in a 20% by mass DMAc solution was measured to be 4,200 P, the viscosity after 24 hours was measured to be 6,500 P, and the viscosity ratio of these was calculated as 1.55.

Furthermore, the number average molecular weight of this polyurethane was 30,000, and there was a peak in the region of the molecular weight (number average molecular weight) of one million or more. Additionally, the amino group concentration of this polyurethane was 6.8 meq/kg.

Next, the 20% by mass DMAc solution of the above polyurethane was concentrated under reduced pressure at 60° C. until the solution became a 35% by mass DMAc solution, mixed with the spinning stock solution obtained in Reference Example 1, and stirred for 2 hours to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,900 P, the viscosity after 24 hours was 4,200 P, and the viscosity ratio of these was calculated as 1.45.

Then, using this dope, a dry spun fiber was obtained in the same manner as in Reference Example 1.

Note that the number average molecular weight of the polymer that constitutes the fiber (or thread) was 30,000.

The results including various evaluations and the like are shown in the table.

### Example 20

Fibrous polyurethane [polyurethane composition (PTMG, MDI, EDA), a crushed product of a thread roll manufactured by a dry spinning method (length of approximately 2 mm, fiber diameter (average fiber diameter) of 560 μm)] was prepared.

Note that, for crushing, crushing was performed until the size became 2 mm using a three-blade helical cutting type crusher.

The initial viscosity of this polyurethane in a 20% by mass DMAc solution was measured to be 4,100 P, the viscosity after 24 hours was measured to be 5,300 P, and the viscosity ratio of these was calculated as 1.29.

Furthermore, the number average molecular weight of this polyurethane was 30,000, and there was no peak in the region of the molecular weight (number average molecular weight) of one million or more. Additionally, the amino group concentration of this polyurethane was 2.0 meq/kg.

Next, the 20% by mass DMAc solution of the above polyurethane was concentrated under reduced pressure at 60° C. until the solution became a 35% by mass DMAc solution, mixed with the spinning stock solution obtained in Reference Example 1, and stirred for 2 hours to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,900 P, the viscosity after 24 hours was 3,000 P, and the viscosity ratio of these was calculated as 1.03.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

### Example 21

Fibrous polyurethane [polyurethane composition (PTMG, MDI, EDA), a crushed product of a thread roll manufactured by a dry spinning method (length of approximately 2 mm, fiber diameter (average fiber diameter) of 560 μm)] was prepared.

Note that, for crushing, crushing was performed until the size became 2 mm using a three-blade helical cutting type crusher.

The initial viscosity of this polyurethane in a 20% by mass DMAc solution was measured to be 4,100 P, the viscosity after 24 hours was measured to be 6,500 P, and the viscosity ratio of these was calculated as 1.59.

Furthermore, the number average molecular weight of this polyurethane was 30,000, and there was no peak in the region of the molecular weight (number average molecular weight) of one million or more. Additionally, the amino group concentration of this polyurethane was 6.8 meq/kg.

Next, the 20% by mass DMAc solution of the above polyurethane was concentrated under reduced pressure at 60° C. until the solution became a 35% by mass DMAc solution, mixed with the spinning stock solution obtained in Reference Example 1, and stirred for 2 hours to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,900 P, the viscosity after 24 hours was 3,000 P, and the viscosity ratio of these was calculated as 1.03.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

### Example 22

Fibrous polyurethane [polyurethane composition (PTMG, MDI, EDA), a crushed product of a thread roll manufactured by a dry spinning method (length of approximately 2 mm, fiber diameter (average fiber diameter) of 560 μm)] was prepared.

Note that, for crushing, crushing was performed until the size became 2 mm using a three-blade helical cutting type crusher.

The initial viscosity of this polyurethane in a 20% by mass DMAc solution was measured to be 4,100 P, the viscosity after 24 hours was measured to be 6,500 P, and the viscosity ratio of these was calculated as 1.59.

Furthermore, the number average molecular weight of this polyurethane was 30,000, and there was no peak in the region of the molecular weight (number average molecular weight) of one million or more. Additionally, the amino group concentration of this polyurethane was 19.8 meq/kg.

Next, the 20% by mass DMAc solution of the above polyurethane was concentrated under reduced pressure at 60° C. until the solution became a 35% by mass DMAc solution, mixed with the spinning stock solution obtained in Reference Example 1, and stirred for 2 hours to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 3,050 P, the viscosity after 24 hours was 4,300 P, and the viscosity ratio of these was calculated as 1.41.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

### Example 23

Fibrous polyurethane [polyurethane composition (PTMG, MDI, EDA), a crushed product of a thread roll manufactured by a dry spinning method (length of approximately 2 mm, fiber diameter (average fiber diameter) of 560 μm)] was prepared.

Note that, for crushing, crushing was performed until the size became 2 mm using a three-blade helical cutting type crusher.

The initial viscosity of this polyurethane in a 20% by mass DMAc solution was measured to be 4,100 P, the viscosity after 24 hours was measured to be 6,500 P, and the viscosity ratio of these was calculated as 1.59.

Furthermore, the number average molecular weight of this polyurethane was 30,000, and there was no peak in the region of the molecular weight (number average molecular weight) of one million or more. Additionally, the amino group concentration of this polyurethane was 28.5 meq/kg.

Next, the 20% by mass DMAc solution of the above polyurethane was concentrated under reduced pressure at 60° C. until the solution became a 35% by mass DMAc solution, mixed with the spinning stock solution obtained in Reference Example 1, and stirred for 2 hours to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 3,500 P, the viscosity after 24 hours was 4,400 P, and the viscosity ratio of these was calculated as 1.26.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

### Example 24

Fibrous polyurethane [polyurethane composition (PTMG, MDI, EDA), a crushed product of a thread roll manufactured by a dry spinning method (length of approximately 2 mm, fiber diameter (average fiber diameter) of 1,265 μm)] was prepared.

Note that, for crushing, crushing was performed until the size became 2 mm using a three-blade helical cutting type crusher.

The initial viscosity of this polyurethane in a 20% by mass DMAc solution was measured to be 2,900 P, the viscosity after 24 hours was measured to be 8,600 P, and the viscosity ratio of these was calculated as 2.97.

Furthermore, the number average molecular weight of this polyurethane was 29,000, and there was a peak in the region of the molecular weight (number average molecular weight) of one million or more. Additionally, the amino group concentration of this polyurethane was 7.2 meq/kg.

Next, the 20% by mass DMAc solution of the above polyurethane was concentrated under reduced pressure at 80° C. until the solution became a 35% by mass DMAc solution, and mixed with the spinning stock solution obtained in Reference Example 1 to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,680 P, the viscosity after 24 hours was 3,800 P, and the viscosity ratio of these was calculated as 1.42.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

### Example 25

Fibrous polyurethane [polyurethane composition (PTMG, MDI, EDA), a crushed product of a thread roll manufactured by a dry spinning method (length of approximately 2 mm, fiber diameter (average fiber diameter) of 1,265 μm)] was prepared.

Note that, for crushing, crushing was performed until the size became 2 mm using a three-blade helical cutting type crusher.

The initial viscosity of this polyurethane in a 20% by mass DMAc solution was measured to be 2,900 P, the viscosity after 24 hours was measured to be 8,300 P, and the viscosity ratio of these was calculated as 2.86.

Furthermore, the number average molecular weight of this polyurethane was 29,000, and there was no peak in the region of the molecular weight (number average molecular weight) of one million or more. Additionally, the amino group concentration of this polyurethane was 0.5 meq/kg.

Next, the 20% by mass DMAc solution of the above polyurethane was concentrated under reduced pressure at 80° C. until the solution became a 35% by mass DMAc solution, and mixed with the spinning stock solution obtained in Reference Example 1 to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,680 P, the viscosity after 24 hours was 3,800 P, and the viscosity ratio of these was calculated as 1.42.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

### Example 26

Fibrous polyurethane [polyurethane composition (PTMG, MDI, EDA), a crushed product of a thread roll manufactured by a dry spinning method (length of approximately 2 mm, fiber diameter (average fiber diameter) of 1,265 μm)] was prepared.

Note that, for crushing, crushing was performed until the size became 2 mm using a three-blade helical cutting type crusher.

The initial viscosity of this polyurethane in a 20% by mass DMAc solution was measured to be 3,000 P, the viscosity after 24 hours was measured to be 8,600 P, and the viscosity ratio of these was calculated as 2.87.

Furthermore, the number average molecular weight of this polyurethane was 29,000, and there was no peak in the region of the molecular weight (number average molecular weight) of one million or more. Additionally, the amino group concentration of this polyurethane was 2.0 meq/kg.

Next, the 20% by mass DMAc solution of the above polyurethane was concentrated under reduced pressure at 80° C. until the solution became a 35% by mass DMAc solution, and mixed with the spinning stock solution obtained in Reference Example 1 to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,750 P, the viscosity after 24 hours was 3,800 P, and the viscosity ratio of these was calculated as 1.38.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

### Example 27

Fibrous polyurethane [polyurethane composition (PTMG, MDI, EDA), a crushed product of a thread roll manufactured by a dry spinning method (length of approximately 2 mm, fiber diameter (average fiber diameter) of 1,265 μm)] was prepared.

Note that, for crushing, crushing was performed until the size became 2 mm using a three-blade helical cutting type crusher.

The initial viscosity of this polyurethane in a 20% by mass DMAc solution was measured to be 3,100 P, the viscosity after 24 hours was measured to be 8,600 P, and the viscosity ratio of these was calculated as 2.77.

Furthermore, the number average molecular weight of this polyurethane was 29,000, and there was no peak in the region of the molecular weight (number average molecular weight) of one million or more. Additionally, the amino group concentration of this polyurethane was 12.4 meq/kg.

Next, the 20% by mass DMAc solution of the above polyurethane was concentrated under reduced pressure at 80° C. until the solution became a 35% by mass DMAc solution, and mixed with the spinning stock solution obtained in Reference Example 1 to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,800 P, the viscosity after 24 hours was 3,800 P, and the viscosity ratio of these was calculated as 1.36.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

### Example 28

Fibrous polyurethane [polyurethane composition (PTMG, MDI, EDA), a crushed product of a thread roll manufactured by a dry spinning method (length of approximately 2 mm, fiber diameter (average fiber diameter) of 1,265 μm)] was prepared.

Note that, for crushing, crushing was performed until the size became 2 mm using a three-blade helical cutting type crusher.

The initial viscosity of this polyurethane in a 20% by mass DMAc solution was measured to be 3,100 P, the viscosity after 24 hours was measured to be 8,750 P, and the viscosity ratio of these was calculated as 2.82.

Furthermore, the number average molecular weight of this polyurethane was 29,000, and there was no peak in the region of the molecular weight (number average molecular weight) of one million or more. Additionally, the amino group concentration of this polyurethane was 20.2 meq/kg.

Next, the 20% by mass DMAc solution of the above polyurethane was concentrated under reduced pressure at 80° C. until the solution became a 35% by mass DMAc solution, and mixed with the spinning stock solution obtained in Reference Example 1 to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,900 P, the viscosity after 24 hours was 3,800 P, and the viscosity ratio of these was calculated as 1.31.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

### Example 29

Fibrous polyurethane [polyurethane composition (PTMG, MDI, EDA), a crushed product of a thread roll manufactured by a dry spinning method (length of approximately 2 mm, fiber diameter (average fiber diameter) of 1,265 μm)] was prepared.

Note that, for crushing, crushing was performed until the size became 2 mm using a three-blade helical cutting type crusher.

The initial viscosity of this polyurethane in a 20% by mass DMAc solution was measured to be 3,200 P, the viscosity after 24 hours was measured to be 8,800 P, and the viscosity ratio of these was calculated as 2.75.

Furthermore, the number average molecular weight of this polyurethane was 29,000, and there was no peak in the region of the molecular weight (number average molecular weight) of one million or more. Additionally, the amino group concentration of this polyurethane was 25.9 meq/kg.

Next, the 20% by mass DMAc solution of the above polyurethane was concentrated under reduced pressure at 80° C. until the solution became a 35% by mass DMAc solution, and mixed with the spinning stock solution obtained in Reference Example 1 to prepare a solution (dope).

Note that a cylindrical container was used for stirring, and a helical ribbon stirring blade covering 85% of the projected outer surface of the bottom of the container was used.

The concentration of this dope was 35% by mass, and the proportion of the above polyurethane in the total solid content (polymer, polyurethane) contained in the dope was set to be 30% by mass.

Furthermore, the initial viscosity of this dope was 2,850 P, the viscosity after 24 hours was 3,800 P, and the viscosity ratio of these was calculated as 1.33.

Then, using this dope, a dry spun fiber was obtained in the same manner as in Reference Example 1.

Note that the number average molecular weight of the polymer that constitutes the fiber (or thread) was 29,000.

The results including various evaluations and the like are shown in the table.

### Example 30

Fibrous polyurethane [polyurethane composition (PTMG, MDI, EDA), a crushed product of a thread roll manufactured by a dry spinning method (length of approximately 2 mm, fiber diameter (average fiber diameter) of 1,205 μm)] was prepared.

Note that, for crushing, crushing was performed until the size became 2 mm using a three-blade helical cutting type crusher.

The initial viscosity of this polyurethane in a 20% by mass DMAc solution was measured to be 4,200 P, the viscosity after 24 hours was measured to be 10,500 P, and the viscosity ratio of these was calculated as 2.50.

Furthermore, the number average molecular weight of this polyurethane was 28,000, and there was a peak in the region of the molecular weight (number average molecular weight) of one million or more. Additionally, the amino group concentration of this polyurethane was 7.7 meq/kg.

Next, the above polyurethane, the spinning stock solution obtained in Reference Example 1, and diethylamine were mixed and stirred for 2 hours to prepare a solution (dope).

Note that a cylindrical container was used for stirring, and a helical ribbon stirring blade covering 85% of the projected outer surface of the bottom of the container was used.

The concentration of this dope was 35% by mass, the proportion of the above polyurethane in the total solid content (polymer, polyurethane) contained in the dope was 30% by mass, and the proportion of diethylamine was set to be 0.2% by mass.

Furthermore, the initial viscosity of this dope was 3,300 P, the viscosity after 24 hours was 4,300 P, and the viscosity ratio of these was calculated as 1.30.

Then, using this dope, a dry spun fiber was obtained in the same manner as in Reference Example 1.

Note that the number average molecular weight of the polymer that constitutes the fiber (or thread) was 44,000.

The results including various evaluations and the like are shown in the table.

### Example 31

Fibrous polyurethane [polyurethane composition (PTMG, MDI, EDA), a crushed product of a thread roll manufactured by a dry spinning method (length of approximately 2 mm, fiber diameter (average fiber diameter) of 1,245 μm)] was prepared.

Note that, for crushing, crushing was performed until the size became 2 mm using a three-blade helical cutting type crusher.

The initial viscosity of this polyurethane in a 20% by mass DMAc solution was measured to be 4,200 P, the viscosity after 24 hours was measured to be 6,600 P, and the viscosity ratio of these was calculated as 1.57.

Furthermore, the number average molecular weight of this polyurethane was 30,000, and there was a peak in the region of the molecular weight (number average molecular weight) of one million or more. Additionally, the amino group concentration of this polyurethane was 6.5 meq/kg.

Next, 2 parts by mass of a 20% by mass DMAc solution of a surfactant (polyoxyethylene styrenated phenyl ether) was combined with 98 parts by mass of a 20% by mass DMAc solution of the above polyurethane to prepare a solution. Then, this was mixed with the spinning stock solution obtained in Reference Example 1.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass, the proportion of the above polyurethane in the total solid content (polymer, polyurethane) contained in the dope was set to be 30% by mass, and the proportion of the surfactant was set to be 0.6% by mass.

Furthermore, the initial viscosity of this dope was 3,300 P, the viscosity after 24 hours was 4,300 P, and the viscosity ratio of these was calculated as 1.30.

Then, using this dope, a dry spun fiber was obtained in the same manner as in Reference Example 1.

Note that the number average molecular weight of the polymer that constitutes the fiber (or thread) was 40,000.

The results including various evaluations and the like are shown in the table.

### Example 32

Fibrous polyurethane [polyurethane composition (PTMG, MDI, EDA), a crushed product of a thread roll manufactured by a dry spinning method (length of approximately 2 mm, fiber diameter (average fiber diameter) of 1,245 μm)] was prepared.

Note that, for crushing, crushing was performed until the size became 2 mm using a three-blade helical cutting type crusher.

The initial viscosity of this polyurethane in a 20% by mass DMAc solution was measured to be 4,200 P, the viscosity after 24 hours was measured to be 9,200 P, and the viscosity ratio of these was calculated as 2.19.

Furthermore, the number average molecular weight of this polyurethane was 30,000, and there was no peak in the region of the molecular weight (number average molecular weight) of one million or more. Additionally, the amino group concentration of this polyurethane was 6.5 meq/kg.

Next, 2 parts by mass of a 20% by mass DMAc solution of a surfactant (polyoxyethylene styrenated phenyl ether) was combined with 98 parts by mass of a 20% by mass DMAc solution of the above polyurethane to prepare a solution. Then, this was mixed with the spinning stock solution obtained in Reference Example 1.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass, the proportion of the above polyurethane in the total solid content (polymer, polyurethane) contained in the dope was set to be 30% by mass, and the proportion of the surfactant was set to be 0.6% by mass.

Furthermore, the initial viscosity of this dope was 3,300 P, the viscosity after 24 hours was 4,300 P, and the viscosity ratio of these was calculated as 1.30.

Then, using this dope, a dry spun fiber was obtained in the same manner as in Reference Example 1.

Note that the number average molecular weight of the polymer that constitutes the fiber (or thread) was 40,000.

The results including various evaluations and the like are shown in the table.

### Example 33

Fibrous polyurethane [polyurethane composition (PTMG, MDI, EDA), a crushed product of a thread roll manufactured by a dry spinning method (length of approximately 2 mm, fiber diameter (average fiber diameter) of 1,245 μm)] was prepared.

Note that, for crushing, crushing was performed until the size became 2 mm using a three-blade helical cutting type crusher.

The initial viscosity of this polyurethane in a 20% by mass DMAc solution was measured to be 4,400 P, the viscosity after 24 hours was measured to be 15,200 P, and the viscosity ratio of these was calculated as 3.45.

Furthermore, the number average molecular weight of this polyurethane was 30,000, and there was no peak in the region of the molecular weight (number average molecular weight) of one million or more. Additionally, the amino group concentration of this polyurethane was 6.6 meq/kg.

Next, 2 parts by mass of a 20% by mass DMAc solution of a surfactant (polyoxyethylene styrenated phenyl ether) was combined with 98 parts by mass of a 20% by mass DMAc solution of the above polyurethane to prepare a solution. Then, this was mixed with the spinning stock solution obtained in Reference Example 1.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass, the proportion of the above polyurethane in the total solid content (polymer, polyurethane) contained in the dope was set to be 30% by mass, and the proportion of the surfactant was set to be 0.6% by mass.

Furthermore, the initial viscosity of this dope was 3,300 P, the viscosity after 24 hours was 4,300 P, and the viscosity ratio of these was calculated as 1.30.

Then, using this dope, a dry spun fiber was obtained in the same manner as in Reference Example 1.

Note that the number average molecular weight of the polymer that constitutes the fiber (or thread) was 40,000.

The results including various evaluations and the like are shown in the table.

### Example 34

Fibrous polyurethane [polyurethane composition (PTMG, MDI, EDA), a crushed product of a thread roll manufactured by a dry spinning method (length of approximately 2 mm, fiber diameter (average fiber diameter) of 1,245 μm)] was prepared.

Note that, for crushing, crushing was performed until the size became 2 mm using a three-blade helical cutting type crusher.

The initial viscosity of this polyurethane in a 20% by mass DMAc solution was measured to be 4,400 P, the viscosity after 24 hours was measured to be 18,400 P, and the viscosity ratio of these was calculated as 4.18.

Furthermore, the number average molecular weight of this polyurethane was 30,000, and there was no peak in the region of the molecular weight (number average molecular weight) of one million or more. Additionally, the amino group concentration of this polyurethane was 7.5 meq/kg.

Next, 2 parts by mass of a 20% by mass DMAc solution of a surfactant (polyoxyethylene styrenated phenyl ether) was combined with 98 parts by mass of a 20% by mass DMAc solution of the above polyurethane to prepare a solution. Then, this was mixed with the spinning stock solution obtained in Reference Example 1.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass, the proportion of the above polyurethane in the total solid content (polymer, polyurethane) contained in the dope was set to be 30% by mass, and the proportion of the surfactant was set to be 0.6% by mass.

Furthermore, the initial viscosity of this dope was 3,300 P, the viscosity after 24 hours was 4,300 P, and the viscosity ratio of these was calculated as 1.30.

Then, using this dope, a dry spun fiber was obtained in the same manner as in Reference Example 1.

Note that the number average molecular weight of the polymer that constitutes the fiber (or thread) was 40,000.

The results including various evaluations and the like are shown in the table.

### Example 35

Fibrous polyurethane [polyurethane composition (PTMG, MDI, EDA), a crushed product of a thread roll manufactured by a dry spinning method (length of approximately 2 mm, fiber diameter (average fiber diameter) of 1,222 μm)] was prepared.

Note that, for crushing, crushing was performed until the size became 2 mm using a three-blade helical cutting type crusher.

The initial viscosity of this polyurethane in a 20% by mass DMAc solution was measured to be 2,800 P, the viscosity after 24 hours was measured to be 9,000 P, and the viscosity ratio of these was calculated as 3.21.

Furthermore, the number average molecular weight of this polyurethane was 33,000, and there was a peak in the region of the molecular weight (number average molecular weight) of one million or more. Additionally, the amino group concentration of this polyurethane was 11.2 meq/kg.

Next, the above polyurethane, the spinning stock solution obtained in Reference Example 1, and a 20% by mass DMAc solution of a hindered phenol antioxidant [ethylene-1,2-bis(3,3-bis[3-t-butyl-4-hydroxyphenyl]butyrate)] were mixed to prepare a solution.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass, the proportion of the above polyurethane in the total solid content (polymer, polyurethane) contained in the dope was set to be 30% by mass, and the proportion of hindered phenol antioxidant was set to be 1.0% by mass.

Furthermore, the initial viscosity of this dope was 4,200 P, the viscosity after 24 hours was 8,080 P, and the viscosity ratio of these was calculated as 1.92.

Then, using this dope, a dry spun fiber was obtained in the same manner as in Reference Example 1.

Note that the number average molecular weight of the polymer that constitutes the fiber (or thread) was 34,000.

The results including various evaluations and the like are shown in the table.

### Example 36

Fibrous polyurethane [polyurethane composition (PTMG, MDI, EDA), a crushed product of a thread roll manufactured by a dry spinning method (length of approximately 2 mm, fiber diameter (average fiber diameter) of 660 μm)] was prepared.

Note that, for crushing, crushing was performed until the size became 2 mm using a three-blade helical cutting type crusher.

The initial viscosity of this polyurethane in a 20% by mass DMAc solution was measured to be 2,800 P, the viscosity after 24 hours was measured to be 9,000 P, and the viscosity ratio of these was calculated as 3.21.

Furthermore, the number average molecular weight of this polyurethane was 33,000, and there was a peak in the region of the molecular weight (number average molecular weight) of one million or more. Additionally, the amino group concentration of this polyurethane was 11.2 meq/kg.

Next, the above polyurethane, a hindered phenol antioxidant [ethylene-1,2-bis(3,3-bis[3-t-butyl-4-hydroxyphenyl]butyrate)], and a 20% by mass DMAc solution of ethylenediamine were mixed to prepare a solution (dope).

Note that a cylindrical container was used for stirring, and a helical ribbon stirring blade covering 85% of the projected outer surface of the bottom of the container was used.

The concentration of this dope was 35% by mass (of which the concentration of the hindered phenolic antioxidant was 0.7% by mass and the concentration of ethylenediamine was 0.07% by mass).

Furthermore, the initial viscosity of this dope was 7,200 P, the viscosity after 24 hours was 12,100 P, and the viscosity ratio of these was calculated as 1.68.

Then, using this dope, a dry spun fiber was obtained in the same manner as in Reference Example 1.

Note that the number average molecular weight of the polymer that constitutes the fiber (or thread) was 53,000.

The results including various evaluations and the like are shown in the table.

### Example 37

A polyurethane urea resin molded product (RIM molded product) [a crushed product comprised of polyurethane urea (PTMG, MDI, EDA) (granular, particle size of approximately 0.1 to 2 mm)] was prepared.

Note that, for crushing, crushing was performed using a three-blade helical cutting type crusher.

The initial viscosity of this polyurethane in a 20% by mass DMAc solution was measured to be 2,900 P, the viscosity after 24 hours was measured to be 3,200 P, and the viscosity ratio of these was calculated as 1.10. Furthermore, the amino group concentration of this polyurethane was 3.7 meq/kg.

Next, the above polyurethane, the spinning stock solution obtained in Reference Example 1, diethylamine, and DMAc were mixed and stirred at 40° C. (ambient temperature) for 2 hours to prepare a solution.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass, the proportion of the above polyurethane in the total solid content (polymer, polyurethane) contained in the dope was 30% by mass, and the proportion of diethylamine was set to be 0.06% by mass.

Furthermore, the initial viscosity of this dope was 3,000 P, the viscosity after 24 hours was 2,800 P, and the viscosity ratio of these was calculated as 0.93.

Then, using this dope, a dry spun fiber was obtained in the same manner as in Reference Example 1.

Note that the number average molecular weight of the polymer that constitutes the fiber (or thread) was 12,000.

The results including various evaluations and the like are shown in the table.

### Example 38

Fibrous polyurethane [polyurethane composition (PTMG, MDI, EDA), a thread roll of a post consumer thread manufactured by a wet spinning method (length of approximately 2 mm, fiber diameter (average fiber diameter) of 660 μm)] was prepared.

Note that, for crushing, crushing was performed until the size became 2 mm using a three-blade helical cutting type crusher.

The initial viscosity of this polyurethane in a 20% by mass DMAc solution was measured to be 2,800 P, the viscosity after 24 hours was measured to be 12,000 P, and the viscosity ratio of these was calculated as 4.29.

Furthermore, the number average molecular weight of this polyurethane was 33,000, and there was no peak in the region of the molecular weight (number average molecular weight) of one million or more. Additionally, the amino group concentration of this polyurethane was 14.8 meq/kg.

Next, the above polyurethane and DMAc were mixed and stirred at 23° C. (ambient temperature) for 2 hours to prepare a solution.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass.

Furthermore, the initial viscosity of this dope was 6,600 P, the viscosity after 24 hours was 13,400 P, and the viscosity ratio of these was calculated as 2.03.

Then, using this dope, a dry spun fiber was obtained in the same manner as in Reference Example 1.

Note that the number average molecular weight of the polymer that constitutes the fiber (or thread) was 34,000.

The results including various evaluations and the like are shown in the table.

### Example 39

Fibrous polyurethane [polyurethane composition (PTMG, MDI, EDA), a thread roll of a post consumer thread manufactured by a wet spinning method (length of approximately 2 mm, fiber diameter (average fiber diameter) of 1,290 μm)] was prepared.

Note that, for crushing, crushing was performed until the size became 2 mm using a three-blade helical cutting type crusher.

The initial viscosity of this polyurethane in a 20% by mass DMAc solution was measured to be 2,200 P, the viscosity after 24 hours was measured to be 8,850 P, and the viscosity ratio of these was calculated as 4.02.

Furthermore, the number average molecular weight of this polyurethane was 33,000, and there was a peak in the region of the molecular weight (number average molecular weight) of one million or more. Additionally, the amino group concentration of this polyurethane was 7.1 meq/kg.

Next, the above polyurethane and DMAc were mixed and stirred at 23° C. (ambient temperature) for 2 hours to prepare a solution.

Note that a cylindrical container was used for stirring, and a helical ribbon stirring blade covering 85% of the projected outer surface of the bottom of the container was used.

Then, the obtained solution was further concentrated to obtain a dope.

The concentration of this dope was 35% by mass.

Furthermore, the initial viscosity of this dope was 3,020 P, the viscosity after 24 hours was 6,450 P, and the viscosity ratio of these was calculated as 2.14.

Then, using this dope, a dry spun fiber was obtained in the same manner as in Reference Example 1.

Note that the number average molecular weight of the polymer that constitutes the fiber (or thread) was 42,000.

### Examples 40 to 52

A fibrous polyurethane [polyurethane composition (PTMG, MDI, EDA), a crushed product of a post consumer thread manufactured by a dry spinning method (length of approximately 2 mm, fiber diameter (average fiber diameter) of 220 μm)] was prepared.

Note that, for crushing, crushing was performed until the size became 2 mm using a three-blade helical cutting type crusher.

Furthermore, the obtained crushed product was dissolved (or dispersed) in DMAc, and then filtered to obtain polyurethane.

For this polyurethane, further treatments [various treatments such as treatment of, after dissolving (or dispersing) in DMAc, adding a predetermined amount of primary amine, adding a predetermined amount of secondary amine, performing heat treatment (adjusting the temperature and heating time), and stirring (adjusting the stirring speed and stirring time), or a combination of these treatments] were carried out to obtain various polyurethanes (A) shown in the table. The physical properties of each polyurethane (A) are as shown in the table.

Then, using each of these polyurethanes (A), each dope was obtained in the same manner as in Reference Example 4.

The concentration of each dope was 35% by mass, and the proportion of the polyurethane in the total solid content (polymer, polyurethane) contained in the dope was set to be 30% by mass.

The physical properties and the like of each dope are as shown in the table.

Then, using each dope, a dry spun fiber was obtained in the same manner as in Reference Example 1. The number average molecular weight of the polymer that constitutes the fiber (or thread) was as shown in the table.

The results including various evaluations and the like are shown in the table.

TABLE 2

| | | | | | | | Dope | | |
|---|---|---|---|---|---|---|---|---|---|
| | Polyurethane (A) | | | | | | Polyurethane | | |
| | | | | | | Amino group | (A)/resin | | |
| | V1 | V2 | | | Peak of Mn 1 | concentration | (solid content) | V1 | V2 |
| | P | P | V2/V1 | Mn | million or more | meq/kg | % by mass | P | P |
| Example 16 | 2900 | 3050 | 1.05 | 30000 | Yes | 2.2 | 30 | 2600 | 2800 |
| Example 17 | 2400 | 3700 | 1.54 | 30000 | No | 0.9 | 30 | 2900 | 2950 |
| Example 18 | 3000 | 3900 | 1.30 | 30500 | Yes | 5.5 | 30 | 2900 | 3200 |
| Example 19 | 4200 | 6500 | 1.55 | 30000 | Yes | 6.8 | 30 | 2900 | 4200 |
| Example 20 | 4100 | 5300 | 1.29 | 30000 | No | 2.0 | 30 | 2900 | 3000 |
| Example 21 | 4100 | 6500 | 1.59 | 30000 | No | 6.8 | 30 | 2900 | 3000 |
| Example 22 | 4100 | 6500 | 1.59 | 30000 | No | 19.8 | 30 | 3050 | 4300 |
| Example 23 | 4100 | 6500 | 1.59 | 30000 | No | 28.5 | 30 | 3500 | 4400 |
| Example 24 | 2900 | 8600 | 2.97 | 29000 | Yes | 7.2 | 30 | 2680 | 3800 |
| Example 25 | 2900 | 8300 | 2.86 | 29000 | No | 0.5 | 30 | 2680 | 3800 |
| Example 26 | 3000 | 8600 | 2.87 | 29000 | No | 2.0 | 30 | 2750 | 3800 |
| Example 27 | 3100 | 8600 | 2.77 | 29000 | No | 12.4 | 30 | 2800 | 3800 |
| Example 28 | 3100 | 8750 | 2.82 | 29000 | No | 20.2 | 30 | 2900 | 3800 |
| Example 29 | 3200 | 8800 | 2.75 | 29000 | No | 25.9 | 30 | 2850 | 3800 |
| Example 30 | 4200 | 10500 | 2.50 | 28000 | Yes | 7.7 | 30 | 3300 | 4300 |
| Example 31 | 4200 | 6600 | 1.57 | 30000 | Yes | 6.5 | 30 | 3300 | 4300 |
| Example 32 | 4200 | 9200 | 2.19 | 30000 | No | 6.5 | 30 | 3300 | 4300 |
| Example 33 | 4400 | 15200 | 3.45 | 30000 | No | 6.6 | 30 | 3300 | 4300 |
| Example 34 | 4400 | 18400 | 4.18 | 30000 | No | 7.5 | 30 | 3300 | 4300 |
| Example 35 | 2800 | 9000 | 3.21 | 33000 | Yes | 11.2 | 30 | 4200 | 8080 |
| Example 36 | 2800 | 9000 | 3.21 | 33000 | Yes | 11.2 | 100 | 7200 | 12100 |
| Example 37 | 2900 | 3200 | 1.10 | — | — | 3.7 | 30 | 3000 | 2800 |
| Example 38 | 2800 | 12000 | 4.29 | 33000 | No | 14.8 | 100 | 6600 | 13400 |
| Example 39 | 2200 | 8850 | 4.02 | 33000 | Yes | 7.1 | 100 | 3020 | 6450 |

| | | | Evaluation | | | | | |
|---|---|---|---|---|---|---|---|---|
| | Dope | | | Rupture | Rupture | Heat | Combined | Yellowing |
| | V2/V1 | Mn | Spinnability | strength | elongation | resistance | durability | resistance |
| Example 16 | 1.08 | 30000 | ◯ | ◯ | ◯ | ◯ | ◯ | ◯ |
| Example 17 | 1.02 | 28000 | Δ | Δ | ◯ | ◯ | ◯ | ⊚ |
| Example 18 | 1.10 | 33000 | ⊚ | ◯ | ◯ | ◯ | ◯ | ◯ |
| Example 19 | 1.45 | 30000 | ⊚ | ⊚ | ⊚ | ⊚ | ◯ | ⊚ |
| Example 20 | 1.03 | 29000 | ◯ | ◯ | ◯ | ◯ | ◯ | ⊚ |
| Example 21 | 1.03 | 29000 | ⊚ | ◯ | ⊚ | ⊚ | ◯ | ⊚ |
| Example 22 | 1.41 | 29000 | ◯ | ◯ | ⊚ | ⊚ | ◯ | ⊚ |
| Example 23 | 1.26 | 29000 | ◯ | ◯ | ◯ | ◯ | ◯ | ◯ |
| Example 24 | 1.42 | 29000 | ⊚ | ⊚ | ⊚ | ⊚ | ◯ | ⊚ |
| Example 25 | 1.42 | 29000 | ◯ | ⊚ | ⊚ | ◯ | ◯ | ⊚ |
| Example 26 | 1.38 | 29000 | ⊚ | ⊚ | ⊚ | ⊚ | ◯ | ⊚ |
| Example 27 | 1.36 | 29000 | ⊚ | ⊚ | ⊚ | ⊚ | ◯ | ⊚ |
| Example 28 | 1.31 | 29000 | ⊚ | ⊚ | ⊚ | ⊚ | ◯ | ⊚ |
| Example 29 | 1.33 | 29000 | ◯ | ◯ | ⊚ | ◯ | ◯ | ⊚ |
| Example 30 | 1.30 | 44000 | ⊚ | ◯ | ◯ | ◯ | ◯ | ◯ |
| Example 31 | 1.30 | 40000 | ⊚ | ◯ | ◯ | ◯ | ◯ | ◯ |
| Example 32 | 1.30 | 40000 | ⊚ | ◯ | ⊚ | ⊚ | ◯ | ⊚ |
| Example 33 | 1.30 | 40000 | ◯ | ◯ | ◯ | ⊚ | ◯ | ⊚ |
| Example 34 | 1.30 | 40000 | ◯ | ◯ | ◯ | ◯ | ◯ | ◯ |
| Example 35 | 1.92 | 34000 | ◯ | ⊚ | ◯ | ◯ | ◯ | ◯ |
| Example 36 | 1.68 | 53000 | ◯ | ◯ | Δ | Δ | ◯ | Δ |
| Example 37 | 0.93 | 12000 | Δ | Δ | Δ | ◯ | — | ◯ |
| Example 38 | 2.03 | 34000 | X | Δ | Δ | Δ | ◯ | ◯ |
| Example 39 | 2.14 | 42000 | Δ | Δ | Δ | Δ | ◯ | ◯ |

TABLE 3

| | | | | | | | Dope | | |
|---|---|---|---|---|---|---|---|---|---|
| | Polyurethane (A) | | | | | | Polyurethane | | |
| | | | | | | Amino group | (A)/resin | | |
| | V1 | V2 | | | Peak of Mn 1 | concentration | (solid content) | V1 | V2 |
| | P | P | V2/V1 | Mn | million or more | meq/kg | % by mass | P | P |
| Example 40 | 2200 | 2100 | 0.95 | 30000 | No | 1 | 30 | 3000 | 2450 |
| Example 41 | 2200 | 2100 | 0.95 | 30000 | No | 1.5 | 30 | 2900 | 2500 |
| Example 42 | 2200 | 2100 | 0.95 | 30000 | No | 2 | 30 | 3000 | 2500 |
| Example 43 | 2200 | 2100 | 0.95 | 30000 | No | 8 | 30 | 3000 | 2700 |
| Example 44 | 2200 | 2100 | 0.95 | 30000 | No | 15 | 30 | 3000 | 3200 |
| Example 45 | 2200 | 2100 | 0.95 | 30000 | No | 20 | 30 | 3000 | 3400 |
| Example 46 | 2200 | 2100 | 0.95 | 31500 | No | 25 | 30 | 3000 | 3650 |
| Example 47 | 2200 | 2150 | 0.98 | 33000 | No | 30 | 30 | 3000 | 3800 |
| Example 48 | 3000 | 3900 | 1.30 | 30000 | No | 2 | 30 | 3050 | 4100 |
| Example 49 | 3000 | 3900 | 1.30 | 30000 | No | 8 | 30 | 3050 | 4300 |
| Example 50 | 3000 | 3900 | 1.30 | 30000 | No | 15 | 30 | 3100 | 4300 |
| Example 51 | 3000 | 4000 | 1.33 | 30000 | No | 20 | 30 | 3200 | 4600 |
| Example 52 | 3000 | 4050 | 1.35 | 31000 | No | 30 | 30 | 3250 | 6300 |

| | | | Evaluation | | | | | |
|---|---|---|---|---|---|---|---|---|
| | Dope | | | Rupture | Rupture | Heat | Combined | Yellowing |
| | V2/V1 | Mn | Spinnability | strength | elongation | resistance | durability | resistance |
| Example 40 | 0.82 | 30000 | Δ | Δ | Δ | Δ | Δ | ◯ |
| Example 41 | 0.86 | 30000 | Δ | Δ | Δ | Δ | Δ | ◯ |
| Example 42 | 0.83 | 30000 | Δ | Δ | Δ | Δ | ◯ | ◯ |
| Example 43 | 0.90 | 30000 | ◯ | Δ | ◯ | ◯ | ◯ | ◯ |
| Example 44 | 1.07 | 30000 | ◯ | ◯ | ◯ | ◯ | ◯ | ◯ |
| Example 45 | 1.13 | 30000 | ◯ | Δ | ◯ | ◯ | ◯ | ◯ |
| Example 46 | 1.22 | 32000 | Δ | ◯ | Δ | Δ | Δ | ◯ |
| Example 47 | 1.27 | 32000 | Δ | Δ | Δ | Δ | Δ | ◯ |
| Example 48 | 1.34 | 30000 | ⊚ | Δ | Δ | ◯ | ◯ | ◯ |
| Example 49 | 1.41 | 30000 | ⊚ | ◯ | ◯ | ◯ | ◯ | ◯ |
| Example 50 | 1.39 | 30000 | ⊚ | ◯ | ◯ | ◯ | ◯ | ◯ |
| Example 51 | 1.44 | 31000 | ⊚ | ◯ | ◯ | ◯ | ◯ | ◯ |
| Example 52 | 1.94 | 31500 | ◯ | Δ | Δ | ◯ | ◯ | Δ |

As is also clear from the table, using the dope (spinning stock solution) combined with the above polyurethane could significantly improve spinnability and resulted in physical properties that were comparable or significantly superior in the obtained fibers as well compared to the case wherein the dope (spinning stock solution) obtained in Reference Example 1 was used.

Then, such a tendency can also be easily realized by using a polyurethane (A) having an amino group, and in particular, was significant in the polyurethane (A) having the amino group at a certain proportion [a proportion that is not too small and/or not too large (in particular, not too small and not too large) (particularly the polyurethane (A) having the above V2/V1 in combination).

Furthermore, by using a polyurethane (A) having such an amino group at a specific proportion, spinnability could be significantly improved even when the polyurethane (A) does not have a peak for a molecular weight of one million or more, exceptionally good results in terms of physical properties could also be obtained for the obtained fibers.

### INDUSTRIAL APPLICABILITY

According to the present invention, an additive or the like can be provided. Such an additive can be suitably used as a dope additive or the like.

1. A dope additive comprised of a polyurethane (A), wherein, when: a viscosity when dissolved in 20% by mass dimethylacetamide at 40° C. is set to be V1; and a viscosity after 24 hours have additionally elapsed at 40° C. after dissolution is set to be V2, the value of V2/V1 value is 1 or more.

2. The additive according to claim 1, wherein the value of V2/V1 of the polyurethane (A) is 1.01 or more.

3. The additive according to claim 1, wherein the value of V2/V1 of the polyurethane (A) is 5 or less.

4. The additive according to claim 1, wherein the value of V2/V1 of the polyurethane (A) is 1.02 to 3.5.

5. The additive according to claim 1, wherein V2 of the polyurethane (A) is 1000 poise or more.

6. The additive according to claim 1, wherein the polyurethane (A) satisfies the following (i) or (ii).
(i) V2 is 1,000 to 5,000 poise, and the value of V2/V1 is 1.05 or more
(ii) V2 is over 5,000 poise and the value of V2/V1 is 3.5 or less

7. The additive according to claim 1, wherein a number average molecular weight of the polyurethane (A) is 10,000 or more.

8. The additive according to claim 1, wherein the polyurethane (A) has a peak in a region of a number average molecular weight of one million or more in GPC.

9. The additive according to claim 1, wherein the polyurethane (A) has an amino group.

10. The additive according to claim 1, wherein the polyurethane (A) has the amino group at a proportion of 0.1 meq/kg or more.

11. The additive according to claim 1, wherein the polyurethane (A) has the amino group at a proportion of 50 meq/kg or less.

12. The additive according to claim 1, wherein the polyurethane (A) has the amino group at a proportion of 0.1 to 50 meq/kg.

13. The additive according to claim 1, wherein the polyurethane (A) has the amino group at a proportion of 1 to 30 meq/kg.

14. The additive according to claim 1, wherein the polyurethane (A) contains a metal soap at a proportion of 0.003 to 3% by mass.

15. The additive according to claim 1, wherein the polyurethane (A) contains a surfactant at a proportion of 0.003 to 3% by mass and/or an antioxidant at a proportion of 0.002 to 5% by mass.

16. The additive according to claim 1, wherein the polyurethane (A) is fibrous.

17. The additive according to claim 1, wherein the polyurethane (A) is at least one type selected from molded products, molding scraps, and post-consumer products that have been stored for one month or more after manufacturing.

18. The additive according to claim 1, being a viscosity modifier.

19. The additive according to claim 1, wherein the dope is a polyurethane dope.

20. An additive, which is a dope additive and comprised of the polyurethane (A) having the amino group at a proportion of 0.1 to 50 meq/kg.

21. An additive, which is a dope additive and comprised of the polyurethane (A) having the amino group at a proportion of 1 to 30 meq/kg.

22. A dope containing the polyurethane (A) according to claim 1.

23. The dope according to claim 22, wherein the proportion of the polyurethane (A) is 1% by mass or more.

24. The dope according to claim 22, further containing a resin (B).

25. The dope according to claim 22, further containing the resin (B), wherein the resin (B) contains a polyurethane (B).

26. The dope according to claim 22, further containing the resin (B), wherein a proportion of the polyurethane (A) relative to a total amount of the polyurethane (A) and the resin (B) is 3% by mass or more.

27. The dope according to claim 22, further containing the resin (B), wherein: the resin (B) contains the polyurethane (B) and a proportion of the polyurethane (A) relative to a total amount of the polyurethane (A) and the polyurethane (B) is 10 to 90% by mass.

28. The dope according to claim 22, wherein a number average molecular weight of the resin constituting the dope is 10,000 or more.

29. The dope according to claim 22, wherein the resin constituting the dope has a peak in a region of a number average molecular weight of one million or more in GPC.

30. The dope according to claim 22, containing a solvent that contains at least one type selected from amide solvents and sulfur solvents.

31. The dope according to claim 22, containing a solvent and having a solid content concentration of 5 to 80% by mass.

32. The dope according to claim 22, wherein, when: a viscosity during preparation at 40° C. is set to be V1; and a viscosity after 24 hours have additionally elapsed at 40° C. after preparation is set to be V2, the value of V2/V1 is 0.8 or more.

33. The dope according to claim 22, wherein, when: a viscosity during preparation at 40° C. is set to be V1; and a viscosity after 24 hours have additionally elapsed at 40° C. after preparation is set to be V2, the value of V2/V1 is 1 to 5.

34. The dope according to claim 22, wherein, when: a viscosity during preparation at 40° C. is set to be V1; and a viscosity after 24 hours have additionally elapsed at 40° C. after preparation is set to be V2, the value of V2/V1 is 1.01 to 3.5; and the viscosity is 1,000 to 10,000 poise.

35. A method for spinning the dope according to claim 22 and producing a fiber.

36. A fiber obtained using the dope according to claim 22.

37. A fiber containing the polyurethane (A) according to claim 1.
